(19) United States
(12) Patent Application Publication
(10) Pub. No.: US 2026/0244015 A1
(43) Pub. Date: Aug. 20, 2026

(54) HEAD-WEARABLE ELECTRONIC DEVICE, METHOD, AND NON-TRANSITORY COMPUTER READABLE STORAGE MEDIUM FOR OBTAINING PERCEPTION DATA

(71) Applicant: Samsung Electronics Co., Ltd., Suwon-si (KR)

(72) Inventors: Jinshik BAE, Suwon-si (KR); Yeongmin HA, Suwon-si (KR); Yongil CHO, Suwon-si (KR); Gyuhyun LEE, Suwon-si (KR); Sungoh KIM, Suwon-si (KR); Sanghun LEE, Suwon-si (KR); Donghyun YEOM, Suwon-si (KR)

(21) Appl. No.: 19/453,491

(22) Filed: Jan. 20, 2026

Related U.S. Application Data
(63) Continuation of application No. PCT/KR2025/023206, filed on Dec. 30, 2025.

(30) Foreign Application Priority Data
Feb. 14, 2025 (KR) 10-2025-0019754
Apr. 23, 2025 (KR) 10-2025-0052983
Jun. 4, 2025 (KR) 10-2025-0073022

(51) Int. Cl. G02B 27/01; H04N 23/667

(52) U.S. Cl. CPC G02B 27/017; H04N 23/667

(57) ABSTRACT

A head-wearable electronic device includes memory storing instructions and at least one processor comprising processing circuitry. The instructions, when executed by the at least one processor, cause the head-wearable electronic device to identify an event requesting perception data generated by utilizing a system resource, identify an operation state of each of perception modules, obtain the requested perception data, through the system resource, based on identifying that the system resource for generating the requested perception data is utilized by one or more of the perception modules in accordance with the identified operation state of each of the perception modules, and start utilizing the system resource, based on identifying that the system resource for generating the requested perception data is not utilized by the perception modules in accordance with the identified operation state of each of the perception modules.

### CROSS-REFERENCE TO RELATED APPLICATION(S)

This application is a continuation application, claiming priority under 35 U.S.C. § 365(c), of an International application No. PCT/KR2025/023206, filed on Dec. 30, 2025, which is based on and claims the benefit of a Korean patent application number 10-2025-0019754, filed on Feb. 14, 2025, in the Ministry of Intellectual Property, of a Korean patent application number 10-2025-0052983, filed on Apr. 23, 2025, in the Ministry of Intellectual Property, and of a Korean patent application number 10-2025-0073022, filed on Jun. 4, 2025, in the Ministry of Intellectual Property, the disclosure of each of which is incorporated by reference herein in its entirety.

### TECHNICAL FIELD

The disclosure relates to a head-wearable electronic device, a method, and a non-transitory computer readable storage medium for obtaining perception data.

### BACKGROUND ART

A wearable device may include a display. The wearable device may include a head-wearable electronic device. The wearable device may be utilized as a tool for implementing virtual reality, augmented reality, and mixed reality. For example, the wearable device may display a three-dimensional (3D) space on the display.

The above information is presented as background information only to assist with an understanding of the disclosure. No determination has been made, and no assertion is made, as to whether any of the above might be applicable as prior art with regard to the disclosure.

### DISCLOSURE

### Technical Solution

Aspects of the disclosure are to address at least the above-mentioned problems and/or disadvantages and to provide at least the advantages described below. Accordingly, an aspect of the disclosure is to provide a head-wearable electronic device, a method, and a non-transitory computer readable storage medium for obtaining perception data.

Additional aspects will be set forth in part in the description which follows and, in part, will be apparent from the description, or may be learned by practice of the presented embodiments.

In accordance with an aspect of the disclosure, a head-wearable electronic device is provided. The head-wearable electronic device may include at least one processor including processing circuitry. The head-wearable electronic device may include memory including one or more storage media storing instructions. The memory communicatively coupled to the at least one processor. The instructions, when executed by the at least one processor individually or collectively, may cause the head-wearable electronic device to identify an event requesting perception data generated by utilizing a system resource. The instructions, when executed by the at least one processor individually or collectively, based on the event, may cause the head-wearable electronic device to identify an operation state of each of perception modules available in the head-wearable electronic device, by using a control module different from the perception modules. The instructions, when executed by the at least one processor individually or collectively, based on identifying, in accordance with the identified operation state of each of the perception modules, that the system resource for generating the requested perception data is being utilized by one or more of the perception modules, may cause the head-wearable electronic device to obtain the requested perception data through the system resource utilized by the one or more of the perception modules. The instructions, when executed by the at least one processor individually or collectively, based on identifying, in accordance with the identified operation state of each of the perception modules, that the system resource for generating the requested perception data is being unutilized by the perception modules, may cause the head-wearable electronic device to start, by using the control module, utilizing the system resource for obtaining the requested perception data.

In accordance with an aspect of the disclosure, a method is provided. The method may be performed by a head-wearable electronic device. The method may include identifying, by at least one processor of the head-wearable device, an event requesting perception data generated by utilizing a system resource. The method may include, based on the event, identifying, by the least one processor, an operation state of each of perception modules available in the head-wearable electronic device, by using a control module different from the perception modules. The method may include, based on identifying, in accordance with the identified operation state of each of the perception modules, that the system resource for generating the requested perception data is being utilized by one or more of the perception modules, obtaining the requested perception data through the system resource utilized by the one or more of the perception modules. The method may include, based on identifying, in accordance with the identified operation state of each of the perception modules, that the system resource for generating the requested perception data is being unutilized by the perception modules, starting, by using the control module, utilizing the system resource for obtaining the requested perception data.

In accordance with an aspect of the disclosure, a non-transitory computer readable storage medium is provided. The non-transitory computer readable storage medium may store one or more computer programs. The one or more computer programs may include computer-executable instructions that, when executed by one or more processors of a head-wearable electronic device individually or collectively, cause the head-wearable electronic device to perform operations. The operations may include identifying an event requesting perception data generated by utilizing a system resource. The operations may include, based on the event, identifying an operation state of each of perception modules available in the head-wearable electronic device, by using a control module different from the perception modules. The operations may include, based on the identifying, in accordance with the identified operation state of each of the perception modules, that the system resource for generating the requested perception data is being utilized by one or more of the perception modules, obtaining the requested perception data through the system resource utilized by the one or more of the perception modules. The operations may include, based on the identifying, in accordance with the identified operation state of each of the perception modules, that the system resource for generating the requested perception data is being unutilized by the perception modules, starting, by using the control module, utilization of the system resource for obtaining the requested perception data.

Other aspects, advantages, and salient features of the disclosure will become apparent to those skilled in the art from the following detailed description, which, taken in conjunction with the annexed drawings, discloses various embodiments of the disclosure.

### DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2A indicates an example of a perspective view of a wearable device according to an embodiment of the disclosure;

FIG. 2B indicates an example of one or more hardware disposed in a wearable device according to an embodiment of the disclosure;

FIGS. 3A and 3B illustrate an example of an exterior of a wearable device according to various embodiments of the disclosure;

FIG. 4 indicates an example of a block diagram of a wearable device according to an embodiment of the disclosure;

FIG. 5 indicates an example of a block diagram of an electronic device for displaying an image in a virtual space according to an embodiment of the disclosure;

FIG. 6 illustrates an example of an operation state of a perception module according to an embodiment of the disclosure;

FIG. 7 illustrates an example of a control module that controls a system resource utilized to obtain perception data according to an embodiment of the disclosure;

FIG. 8 illustrates an example of operations of a head-wearable electronic device for obtaining perception data according to an embodiment of the disclosure;

FIG. 9 illustrates an example of operations of a head-wearable electronic device that obtains perception data by performing scheduling of at least one processor according to an embodiment of the disclosure;

FIG. 10 illustrates an example of operations of a head-wearable electronic device that obtains perception data by performing memory resource allocation according to an embodiment of the disclosure; and

FIGS. 11A, 11B, and 11C illustrate an example in which an operation state of a perception module and a state of one or more cameras are changed according to various embodiments of the disclosure.

The same reference numerals are used to represent the same elements throughout the drawings.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In various embodiments of the disclosure described below, a hardware approach will be described as an example. However, since the various embodiments of the disclosure include technology that uses both hardware and software, the various embodiments of the disclosure do not exclude a software-based approach.

A term (e.g., data, information, signal, control signal, and request) referring to data, a term referring to a value, a term (e.g., operation, process, and task) for a calculation state, a term referring to an object, a term referring to network entities, a term referring to a component of a device, and the like, used in the following description, are exemplified for convenience of description. Therefore, the disclosure is not limited to terms to be described below, and another term having an equivalent technical meaning may be used. In addition, a term such as ‘. . . unit’, ‘. . . device’, ‘. . . object’, and ‘. . . structure’, and the like used below may mean at least one shape structure or may mean a unit processing a function.

In addition, in the disclosure, the term ‘greater than’ or ‘less than’ may be used to determine whether a particular condition is satisfied or fulfilled, but this is only a description to express an example and does not exclude description of ‘greater than or equal to’ or ‘less than or equal to’. A condition described as ‘greater than or equal to’ may be replaced with ‘greater than’, a condition described as ‘less than or equal to’ may be replaced with ‘less than’, and a condition described as ‘greater than or equal to and less than’ may be replaced with ‘greater than and less than or equal to’. In addition, hereinafter, ‘A’ to ‘B’ refers to at least one of elements from A (including A) to B (including B). Hereinafter, ‘C’ and/or ‘D’ means including at least one of ‘C’ or ‘D’, that is, {‘C’, ‘D’, and ‘C’and ‘D’}.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

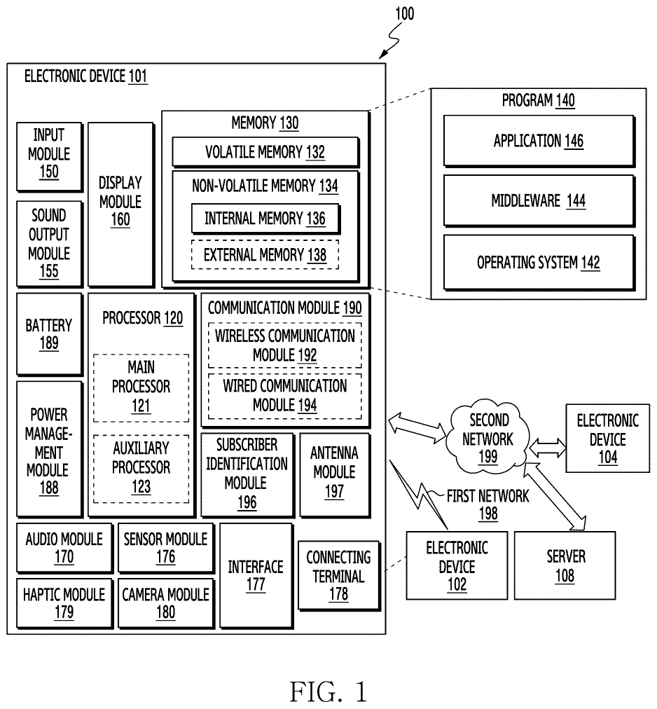

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or user plane (U-plane) latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

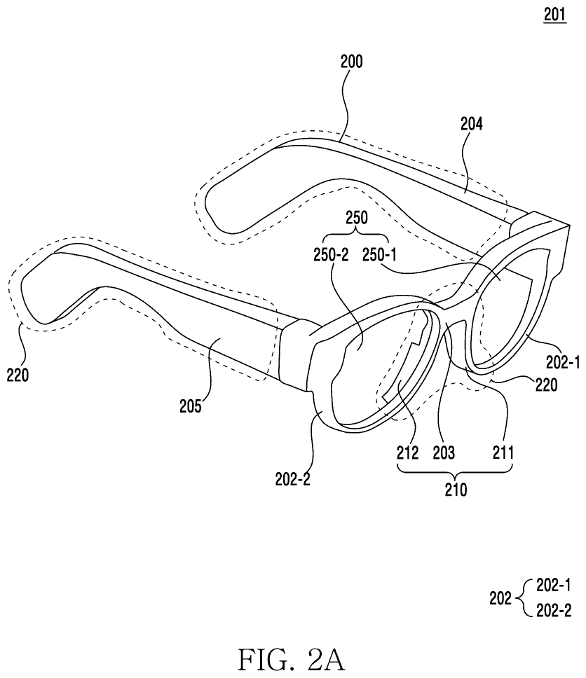

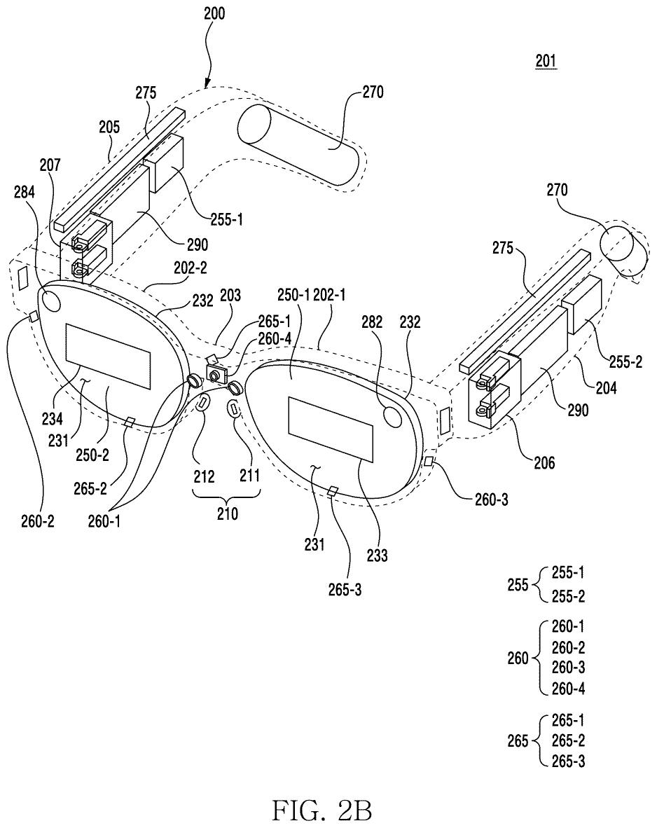

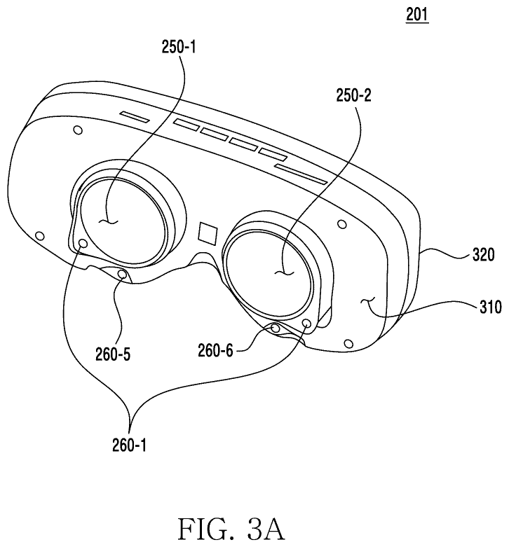

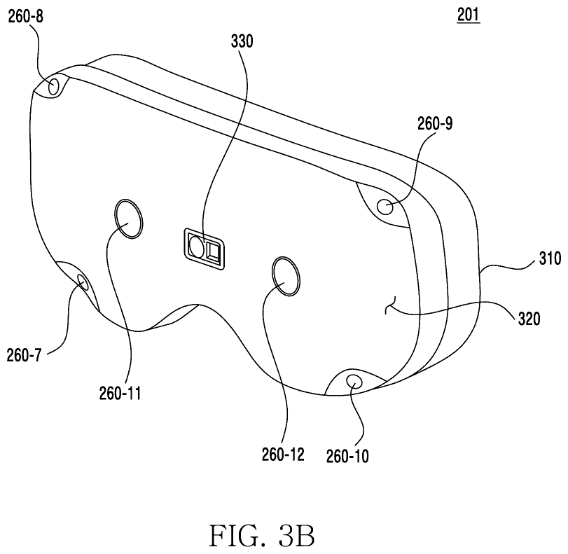

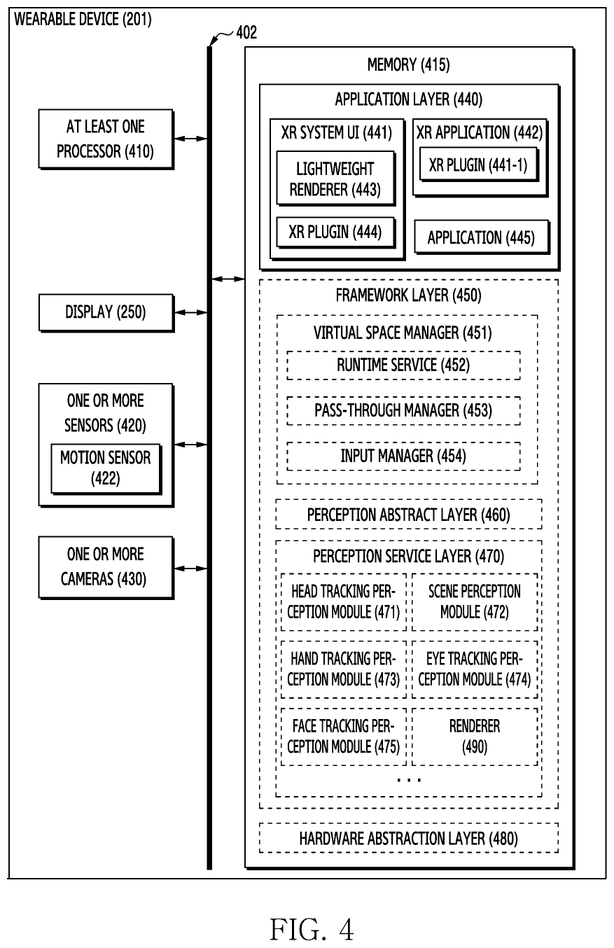

In embodiments of the disclosure, the electronic device 101 may display an image representing a virtual space. For example, the electronic device 101 displaying the image representing the virtual space may be a wearable device. For example, the wearable device may include a head-wearable electronic device. The wearable device may include a head-mounted display (HMD) wearable on a head of the user. The wearable device may be referred to as a head-mount device (HMD), a headgear electronic device, a glasses-type electronic device, a video see-through or visible see-through (VST) device, an extended reality (XR) device, a virtual reality (VR) device, and/or an augmented reality (AR) device. Although an appearance of the wearable device having a form of glasses is illustrated, an embodiment is not limited thereto. An example of a hardware configuration included in the wearable device will be exemplarily described with reference to FIG. 4. An example of a structure of the wearable device (e.g., a wearable device 201) wearable on the head of the user will be described with reference to FIGS. 2A, 2B, 3A, and/or 3B. The wearable device may be referred to as the electronic device. For example, the electronic device may form the HMD by being coupled with an accessory (e.g., a strap) to be attached to the head of the user.

The wearable device according to an embodiment may execute a function associated with the augmented reality (AR) and/or a mixed reality (MR). For example, in a state that the user is wearing the wearable device, the wearable device may include at least one lens disposed adjacent to an eye of the user. The wearable device may couple ambient light passing through the lens with light emitted from a display of the wearable device. A displaying region of the display may be formed in the lens through which the ambient light passes. Since the wearable device couples the ambient light and the light emitted from the display, the user may view an image in which a real object perceived by the ambient light and a virtual object formed by the light emitted from the display are mixed. The above-described augmented reality, mixed reality, and/or virtual reality may be referred to as the extended reality (XR).

The wearable device according to an embodiment may execute a function associated with the video see-through or the visible see-through (VST) and/or the virtual reality (VR). For example, in the state that the user is wearing the wearable device, the wearable device may include a housing covering the eye of the user. The wearable device may include a display disposed on a first surface of the housing facing the eye in the state. The wearable device may include a camera disposed on a second surface opposite to the first surface. Using the camera, the wearable device may obtain an image and/or a video representing the ambient light. The wearable device may enable the user to perceive the ambient light through the display by outputting the image and/or the video in the display disposed on the first surface. The displaying region (or the displaying area) (or an active region (or an active area)) of the display disposed on the first surface may be formed by one or more pixels included in the display. The wearable device may enable the user to perceive the virtual object together with the real object perceived by the ambient light by synthesizing the virtual object with the image and/or the video outputted through the display.

The wearable device according to an embodiment may identify or perceive (or recognize) a position (or a location) and/or a direction (or an orientation) of the wearable device based on the image (and/or the video) obtained (or acquired) using the camera. The wearable device may obtain information on the external space using one or more cameras and/or one or more sensors. The information may include a geographic location (e.g., a global positioning system (GPS) coordinate) of the external space identified from the one or more sensors. The information may include an image and/or a video of the external space identified from the one or more cameras. The wearable device may identify, from the image and/or the video, external objects included in the external space by performing an object perception on the image and/or the video.

Hereinafter, an example of the hardware configuration of the wearable device (e.g., the wearable device 201) will be described with reference to FIGS. 2A, 2B, 3A, 3B, and 4.

FIG. 2A illustrates an example of a perspective view of a wearable device according to an embodiment of the disclosure. FIG. 2B illustrates an example of one or more hardware disposed in a wearable device according to an embodiment of the disclosure. A wearable device 201 according to an embodiment may have a form of glasses wearable on a part (e.g., a head) of a body of a user. For example, the wearable device 201 may be referred to as a head-wearable electronic device. The wearable device 201 of FIGS. 2A and 2B may be an example of the electronic device 101 of FIG. 1. The wearable device 201 may include a head-mounted display (HMD). For example, a housing of the wearable device 201 may include rubber and/or a flexible material such as silicone having a form of being in close contact with a part (e.g., a part of a face covering both eyes) of the head of the user. For example, the housing of the wearable device 201 may include one or more straps that are able to be twined around the head of the user and/or one or more temples that are attachable to an ear of the head.

Referring to FIG. 2A, according to an embodiment, the wearable device 201 may include at least one display 250 and a frame 200 supporting the at least one display 250.

According to an embodiment, the wearable device 201 may be wearable on a portion of the user's body. The wearable device 201 may provide augmented reality (AR), virtual reality (VR), or mixed reality (MR) combining the augmented reality and the virtual reality to a user wearing the wearable device 201. For example, the wearable device 201 may display a virtual reality image provided from at least one optical device 282 and 284 of FIG. 2B on at least one display 250, in response to a user's preset gesture obtained through a motion recognition camera 260-2 and 260-3 of FIG. 2B.

According to an embodiment, the at least one display 250 may provide visual information to a user. For example, the at least one display 250 may include a transparent or translucent lens. The at least one display 250 may include a first display 250-1 and/or a second display 250-2 spaced apart from the first display 250-1. For example, the first display 250-1 and the second display 250-2 may be disposed at positions corresponding to the user's left and right eyes, respectively.

Referring to FIG. 2B, the at least one display 250 may provide visual information transmitted through a lens included in the at least one display 250 from ambient light to a user and other visual information distinguished from the visual information2. The lens may be formed based on at least one of a fresnel lens, a pancake lens, or a multi-channel lens. For example, the at least one display 250 may include a first surface 231 and a second surface 232 opposite to the first surface 231. A display area may be formed on the second surface 232 of at least one display 250. When the user wears the wearable device 201, ambient light may be transmitted to the user by being incident on the first surface 231 and being penetrated through the second surface 232. For another example, the at least one display 250 may display an augmented reality image in which a virtual reality image provided by the at least one optical device 282 and 284 is combined with a reality screen transmitted through ambient light, on a display area formed on the second surface 232.

According to an embodiment, the at least one display 250 may include at least one waveguide 233 and 234 that transmits light transmitted from the at least one optical device 282 and 284 by diffracting to the user. The at least one waveguide 233 and 234 may be formed based on at least one of glass, plastic, or polymer. A nano pattern may be formed on at least a portion of the outside or inside of the at least one waveguide 233 and 234. The nano pattern may be formed based on a grating structure having a polygonal or curved shape. Light incident to an end of the at least one waveguide 233 and 234 may be propagated to another end of the at least one waveguide 233 and 234 by the nano pattern. The at least one waveguide 233 and 234 may include at least one of at least one diffraction element (e.g., a diffractive optical element (DOE), a holographic optical element (HOE)), and a reflection element (e.g., a reflection mirror). For example, the at least one waveguide 233 and 234 may be disposed in the wearable device 201 to guide a screen displayed by the at least one display 250 to the user's eyes. For example, the screen may be transmitted to the user's eyes based on total internal reflection (TIR) generated in the at least one waveguide 233 and 234.

The wearable device 201 may analyze an object included in a real image collected through a photographing camera 260-4, combine with a virtual object corresponding to an object that becomes a subject of augmented reality provision among the analyzed object, and display on the at least one display 250. The virtual object may include at least one of text and images for various information associated with the object included in the real image. The wearable device 201 may analyze the object based on a multi-camera such as a stereo camera. For the object analysis, the wearable device 201 may execute space recognition (e.g., simultaneous localization and mapping (SLAM)) using the multi-camera and/or time-of-flight (ToF). The user wearing the wearable device 201 may watch an image displayed on the at least one display 250.

According to an embodiment, a frame 200 may be configured with a physical structure in which the wearable device 201 may be worn on the user's body. According to an embodiment, the frame 200 may be configured so that when the user wears the wearable device 201, the first display 250-1 and the second display 250-2 may be positioned corresponding to the user's left and right eyes. The frame 200 may support the at least one display 250. For example, the frame 200 may support the first display 250-1 and the second display 250-2 to be positioned at positions corresponding to the user's left and right eyes.

Referring to FIG. 2A, according to an embodiment, the frame 200 may include an area 220 at least partially in contact with the portion of the user's body in case that the user wears the wearable device 201. For example, the area 220 of the frame 200 in contact with the portion of the user's body may include an area in contact with a portion of the user's nose, a portion of the user's ear, and a portion of the side of the user's face that the wearable device 201 contacts. According to an embodiment, the frame 200 may include a nose pad 210 that is contacted on the portion of the user's body. When the wearable device 201 is worn by the user, the nose pad 210 may be contacted on the portion of the user's nose. The frame 200 may include a first temple 204 and a second temple 205, which are contacted on another portion of the user's body that is distinct from the portion of the user's body.

For example, the frame 200 may include a first rim 202-1 surrounding at least a portion of the first display 250-1, a second rim 202-2 surrounding at least a portion of the second display 250-2, a bridge 203 disposed between the first rim 202-1 and the second rim 202-2, a first pad 211 disposed along a portion of the edge of the first rim 202-1 from one end of the bridge 203, a second pad 212 disposed along a portion of the edge of the second rim 202-2 from the other end of the bridge 203, the first temple 204 extending from the first rim 202-1 and fixed to a portion of the wearer's ear, and the second temple 205 extending from the second rim 202-2 and fixed to a portion of the ear opposite to the ear. The first pad 211 and the second pad 212 may be in contact with the portion of the user's nose, and the first temple 204 and the second temple 205 may be in contact with a portion of the user's face and the portion of the user's ear. The temples 204 and 205 may be rotatably connected to the rim through hinge units 206 and 207 of FIG. 2B. The first temple 204 may be rotatably connected with respect to the first rim 202-1 through the first hinge unit 206 disposed between the first rim 202-1 and the first temple 204. The second temple 205 may be rotatably connected with respect to the second rim 202-2 through the second hinge unit 207 disposed between the second rim 202-2 and the second temple 205. According to an embodiment, the wearable device 201 may identify an external object (e.g., a user's fingertip) touching the frame 200 and/or a gesture performed by the external object by using a touch sensor, a grip sensor, and/or a proximity sensor formed on at least a portion of the surface of the frame 200.

According to an embodiment, the wearable device 201 may include hardware (e.g., hardware described to be later based on the block diagram of FIG. 4) that performs various functions. For example, the hardware may include a battery module 270, an antenna module 275, the at least one optical device 282 and 284, speakers (e.g., speakers 255-1 and 255-2), a microphone (e.g., microphones 265-1, 265-2, and 265-3), a light emitting module (not illustrated), and/or a printed circuit board (PCB) 290 (e.g., printed circuit board). Various hardware may be disposed in the frame 200.

According to an embodiment, the microphone (e.g., the microphones 265-1, 265-2, and 265-3) of the wearable device 201 may obtain a sound signal, by being disposed on at least a portion of the frame 200. The first microphone 265-1 disposed on the bridge 203, the second microphone 265-2 disposed on the second rim 202-2, and the third microphone 265-3 disposed on the first rim 202-1 are illustrated in FIG. 2B, but the number and disposition of the microphone 265 are not limited to an embodiment of FIG. 2B. In case that the number of the microphone 265 included in the wearable device 201 is two or more, the wearable device 201 may identify a direction of the sound signal by using a plurality of microphones disposed on different portions of the frame 200.

According to an embodiment, the at least one optical device 282 and 284 may project a virtual object on the at least one display 250 in order to provide various image information to the user. For example, the at least one optical device 282 and 284 may be a projector. The at least one optical device 282 and 284 may be disposed adjacent to the at least one display 250 or may be included in the at least one display 250 as a portion of the at least one display 250. According to an embodiment, the wearable device 201 may include a first optical device 282 corresponding to the first display 250-1, and a second optical device 284 corresponding to the second display 250-2. For example, the at least one optical device 282 and 284 may include the first optical device 282 disposed at a periphery of the first display 250-1 and the second optical device 284 disposed at a periphery of the second display 250-2. The first optical device 282 may transmit light to the first waveguide 233 disposed on the first display 250-1, and the second optical device 284 may transmit light to the second waveguide 234 disposed on the second display 250-2.

In an embodiment, a camera 260 may include the photographing camera 260-4, an eye tracking camera (ET CAM) 260-1, and/or the motion recognition camera 260-2 and 260-3. The photographing camera 260-4, the eye tracking camera 260-1, and the motion recognition camera 260-2 and 260-3 may be disposed at different positions on the frame 200 and may perform different functions. The eye tracking camera 260-1 may output data indicating a position of eye or a gaze of the user wearing the wearable device 201. For example, the wearable device 201 may detect the gaze from an image including the user's pupil obtained through the eye tracking camera 260-1. The wearable device 201 may identify an object (e.g., a real object, and/or a virtual object) focused by the user, by using the user's gaze obtained through the eye tracking camera 260-1. The wearable device 201 identifying the focused object may execute a function (e.g., gaze interaction) for interaction between the user and the focused object. The wearable device 201 may represent a portion corresponding to eye of an avatar indicating the user in the virtual space, by using the user's gaze obtained through the eye tracking camera 260-1. The wearable device 201 may render an image (or a screen) displayed on the at least one display 250, based on the position of the user's eye. For example, visual quality (e.g., resolution, brightness, saturation, grayscale, and pixels per inch (PPI)) of a first area related to the gaze within the image and visual quality of a second area distinguished from the first area may be different. In the disclosure, the term “resolution” is used to refer to the density of pixels of an image and/or the display 250. The density and/or resolution of pixels may be measured or parameterized, based on a unit of PPI and/or dot per inch (dpi). The wearable device 201 may obtain an image having the visual quality of the first area matching the user's gaze and the visual quality of the second area by using foveated rendering. For example, when the wearable device 201 supports an iris recognition function, user authentication may be performed based on iris information obtained using the eye tracking camera 260-1. An example in which the eye tracking camera 260-1 is disposed toward the user's right eye is illustrated in FIG. 2B, but the embodiment is not limited thereto, and the eye tracking camera 260-1 may be disposed alone toward the user's left eye or may be disposed toward two eyes.

In an embodiment, the photographing camera 260-4 may photograph a real image or background to be matched with a virtual image in order to implement the augmented reality or mixed reality content. The photographing camera 260-4 may be used to obtain an image having a high resolution based on a high resolution (HR) or a photo video (PV). The photographing camera 260-4 may photograph an image of a specific object existing at a position viewed by the user and may provide the image to the at least one display 250. The at least one display 250 may display one image in which a virtual image provided through the at least one optical device 282 and 284 is overlapped with information on the real image or background including an image of the specific object obtained by using the photographing camera 260-4. The wearable device 201 may compensate for depth information (e.g., a distance between the wearable device 201 and an external object obtained through a depth sensor), by using an image obtained through the photographing camera 260-4. The wearable device 201 may perform object recognition through an image obtained using the photographing camera 260-4. The wearable device 201 may perform a function (e.g., auto focus) of focusing an object (or subject) within an image and/or an optical image stabilization (OIS) function (e.g., an anti-shaking function) by using the photographing camera 260-4. While displaying a screen representing a virtual space on the at least one display 250, the wearable device 201 may perform a pass through function for displaying an image obtained through the photographing camera 260-4 overlapping at least a portion of the screen. In an embodiment, the photographing camera 260-4 may be disposed on the bridge 203 disposed between the first rim 202-1 and the second rim 202-2.

The eye tracking camera 260-1 may implement a more realistic augmented reality by matching the user's gaze with the visual information provided on the at least one display 250, by tracking the gaze of the user wearing the wearable device 201. For example, when the user looks at the front, the wearable device 201 may naturally display environment information associated with the user's front on the at least one display 250 at a position where the user is positioned. The eye tracking camera 260-1 may be configured to capture an image of the user's pupil in order to determine the user's gaze. For example, the eye tracking camera 260-1 may receive gaze detection light reflected from the user's pupil and may track the user's gaze based on the position and movement of the received gaze detection light. In an embodiment, the eye tracking camera 260-1 may be disposed at a position corresponding to the user's left and right eyes. For example, the eye tracking camera 260-1 may be disposed in the first rim 202-1 and/or the second rim 202-2 to face the direction in which the user wearing the wearable device 201 is positioned.

The motion recognition camera 260-2 and 260-3 may provide a specific event to the screen provided on the at least one display 250 by recognizing the movement of the whole or portion of the user's body, such as the user's torso, hand, or face. The motion recognition camera 260-2 and 260-3 may obtain a signal corresponding to motion by recognizing the user's motion (e.g., gesture recognition), and may provide a display corresponding to the signal to the at least one display 250. The processor may identify a signal corresponding to the operation and may perform a preset function based on the identification. The motion recognition camera 260-2 and 260-3 may be used to perform simultaneous localization and mapping (SLAM) for 6 degrees of freedom pose (6 dof pose) and/or a space recognition function using a depth map. The processor may perform a gesture recognition function and/or an object tracking function, by using the motion recognition camera 260-2 and 260-3. In an embodiment, the motion recognition camera 260-2 and camera 260-3 may be disposed on the first rim 202-1 and/or the second rim 202-2.

The camera 260 included in the wearable device 201 is not limited to the above-described eye tracking camera 260-1 and the motion recognition camera 260-2 and 260-3. For example, the wearable device 201 may identify an external object included in the field of view (FoV) by using a camera disposed toward the user's FoV. The wearable device 201 identifying the external object may be performed based on a sensor for identifying a distance between the wearable device 201 and the external object, such as a depth sensor and/or a time of flight (ToF) sensor. The camera 260 disposed toward the FoV may support an autofocus function and/or an optical image stabilization (OIS) function. For example, in order to obtain an image including a face of the user wearing the wearable device 201, the wearable device 201 may include the camera 260 (e.g., a face tracking (FT) camera) disposed toward the face.

Although not illustrated, the wearable device 201 according to an embodiment may further include a light source (e.g., light emitting diode (LED)) that emits light toward a subject (e.g., user's eyes, face, and/or an external object in the FoV) photographed by using the camera 260. The light source may include an LED having an infrared wavelength. The light source may be disposed on at least one of the frame 200, and the hinge units 206 and 207.

According to an embodiment, the battery module 270 may supply power to electronic components of the wearable device 201. In an embodiment, the battery module 270 may be disposed in the first temple 204 and/or the second temple 205. For example, the battery module 270 may be a plurality of battery modules 270. The plurality of battery modules 270, respectively, may be disposed on each of the first temple 204 and the second temple 205. In an embodiment, the battery module 270 may be disposed at an end of the first temple 204 and/or the second temple 205.

The antenna module 275 may transmit the signal or power to the outside of the wearable device 201 or may receive the signal or power from the outside. In an embodiment, the antenna module 275 may be disposed in the first temple 204 and/or the second temple 205. For example, the antenna module 275 may be disposed close to one surface of the first temple 204 and/or the second temple 205.

The speaker 255 may output a sound signal to the outside of the wearable device 201. A sound output module may be referred to as a speaker. In an embodiment, the speaker 255 may be disposed in the first temple 204 and/or the second temple 205 in order to be disposed adjacent to the ear of the user wearing the wearable device 201. For example, the speaker 255 may include a second speaker 255-2 disposed adjacent to the user's left ear by being disposed in the first temple 204, and a first speaker 255-1 disposed adjacent to the user's right ear by being disposed in the second temple 205.

The light emitting module (not illustrated) may include at least one light emitting element. The light emitting module may emit light of a color corresponding to a specific state or may emit light through an operation corresponding to the specific state in order to visually provide information on a specific state of the wearable device 201 to the user. For example, when the wearable device 201 requires charging, it may emit red light at a constant cycle. In an embodiment, the light emitting module may be disposed on the first rim 202-1 and/or the second rim 202-2.

Referring to FIG. 2B, according to an embodiment, the wearable device 201 may include the printed circuit board (PCB) 290. The PCB 290 may be included in at least one of the first temple 204 or the second temple 205. The PCB 290 may include an interposer disposed between at least two sub PCBs. On the PCB 290, one or more hardware (e.g., hardware illustrated by different blocks of FIG. 4) included in the wearable device 201 may be disposed. The wearable device 201 may include a flexible PCB (FPCB) for interconnecting the hardware.

According to an embodiment, the wearable device 201 may include at least one of a gyro sensor, a gravity sensor, and/or an acceleration sensor for detecting the posture of the wearable device 201 and/or the posture of a body part (e.g., a head) of the user wearing the wearable device 201. Each of the gravity sensor and the acceleration sensor may measure gravity acceleration, and/or acceleration based on preset 3-dimensional axes (e.g., x-axis, y-axis, and z-axis) perpendicular to each other. The gyro sensor may measure angular velocity of each of preset 3-dimensional axes (e.g., x-axis, y-axis, and z-axis). At least one of the gravity sensor, the acceleration sensor, and the gyro sensor may be referred to as an inertial measurement unit (IMU). According to an embodiment, the wearable device 201 may identify the user's motion and/or gesture performed to execute or stop a specific function of the wearable device 201 based on the IMU.

FIGS. 3A and 3B illustrate an example of an exterior of a wearable device according to various embodiments of the disclosure. The wearable device 201 may be an example of the electronic device 101 of FIG. 1. According to an embodiment, an example of an exterior of a first surface 310 of a housing of the wearable device 201 may be illustrated in FIG. 3A, and an example of an exterior of a second surface 320 opposite to the first surface 310 may be illustrated in FIG. 3B.

Referring to FIG. 3A, according to an embodiment, the first surface 310 of the wearable device 201 may have an attachable shape on the user's body part (e.g., the user's face). Although not illustrated, the wearable device 201 may further include a strap for being fixed on the user's body part, and/or one or more temples (e.g., the first temple 204 and/or the second temple 205 of FIGS. 2A and 2B). A first display 250-1 for outputting an image to the left eye among the user's two eyes and a second display 250-2 for outputting an image to the right eye among the user's two eyes may be disposed on the first surface 310. The wearable device 201 may further include rubber or silicon packing, which are formed on the first surface 310, for preventing interference by light (e.g., ambient light) different from the light emitted from the first display 250-1 and the second display 250-2.

According to an embodiment, the wearable device 201 may include cameras 260-1 for photographing and/or tracking two eyes of the user adjacent to each of the first display 250-1 and the second display 250-2. The cameras 260-1 may be referred to as the gaze tracking camera 260-1 of FIG. 2B. According to an embodiment, the wearable device 201 may include cameras 260-5 and 260-6 for photographing and/or recognizing the user's face. The cameras 260-5 and 260-6 may be referred to as a FT camera. The wearable device 201 may control an avatar representing a user in a virtual space, based on a motion of the user's face identified using the cameras 260-5 and 260-6. For example, the wearable device 201 may change a texture and/or a shape of a portion (e.g., a portion of an avatar representing a human face) of the avatar, by using information obtained by the cameras 260-5 and 260-6 (e.g., the FT camera) and representing the facial expression of the user wearing the wearable device 201.

Referring to FIG. 3B, a camera (e.g., cameras 260-7, 260-8, 260-9, 260-10, 260-11, and 260-12), and/or a sensor (e.g., the depth sensor 330) for obtaining information associated with the external environment of the wearable device 201 may be disposed on the second surface 320 opposite to the first surface 310 of FIG. 3A. For example, the cameras 260-7, 260-8, 260-9, and 260-10 may be disposed on the second surface 320 in order to recognize an external object. The cameras 260-7, 260-8, 260-9, and 260-10 may be referred to as the motion recognition cameras 260-2 and 260-3 of FIG. 2B.

For example, by using cameras 260-11 and 260-12, the wearable device 201 may obtain an image and/or video to be transmitted to each of the user's two eyes. The camera 260-11 may be disposed on the second surface 320 of the wearable device 201 to obtain an image to be displayed through the second display 250-2 corresponding to the right eye among the two eyes. The camera 260-12 may be disposed on the second surface 320 of the wearable device 201 to obtain an image to be displayed through the first display 250-1 corresponding to the left eye among the two eyes. The cameras 260-11 and 260-12 may be referred to as the photographing camera 260-4 of FIG. 2B.

According to an embodiment, the wearable device 201 may include the depth sensor 330 disposed on the second surface 320 in order to identify a distance between the wearable device 201 and the external object. By using the depth sensor 330, the wearable device 201 may obtain spatial information (e.g., a depth map) about at least a portion of the FoV of the user wearing the wearable device 201. Although not illustrated, a microphone for obtaining sound outputted from the external object may be disposed on the second surface 320 of the wearable device 201. The number of microphones may be one or more according to embodiments.

Hereinafter, a hardware or software configuration of the wearable device 201 will be described later with reference to FIG. 4.

FIG. 4 illustrates an example of a block diagram of a wearable device according to an embodiment of the disclosure. The wearable device 201 may be an example of the electronic device 101 of FIG. 1.

Referring to FIG. 4, the wearable device 201 according to an embodiment may include at least one processor 410, memory 415, a display 250 (e.g., the first display 250-1 and/or the second display 250-2 of FIGS. 2A, 2B, 3A, and 3B), one or more sensors 420 (e.g., motion sensor 422), and/or one or more cameras 430. The at least one processor 410, the memory 415, the display 250, the one or more sensors 420, and/or the one or more cameras 430 may be electrically and/or operably connected to each other by an electronic component such as a communication bus 402. In the disclosure, an operational connection of electronic components may include a direct connection established between the electronic components and/or an indirect connection established between the electronic components such that a first electronic component of the electronic components is controlled by a second electronic component of the electronic components. The type and/or number of electronic components included in the wearable device 201 is not limited as illustrated in FIG. 4. For example, the wearable device 201 may include only some of the components illustrated in FIG. 4.

According to an embodiment, the processor 410 of the wearable device 201 may include circuitry (e.g., processing circuitry) for processing data, based on one or more instructions. For example, the circuitry for processing data may include an arithmetic and logic unit (ALU), a field programmable gate array (FPGA), a central processing unit (CPU) and/or an application processor (AP). According to an embodiment, a structure of the at least one processor 410 is not limited to an embodiment of the disclosure, and at least one circuit may be formed as a separate processor physically separated outside the at least one processor. The at least one processor 410 may have a structure of a multi-core processor such as a dual core, a quad core, a hexa core, and/or an octa core. The multi-core processor structure of the processor 410 may include a structure (e.g., a big-little structure) based on a plurality of core circuits, divided by power consumption, clock, and/or computational amount per unit time. In an embodiment including the at least one processor 410 having a multi-core processor structure, operations and/or functions of the disclosure may be performed individually or collectively by one or more cores included in the at least one processor 410.

According to an embodiment, the memory 415 of the wearable device 201 may include an electronic component for storing data and/or instructions inputted to the at least one processor 410 and/or outputted from the at least one processor 410. For example, the memory 415 may include volatile memory such as a random-access memory (RAM) and/or non-volatile memory such as read-only memory (ROM). For example, the volatile memory may include at least one of dynamic RAM (DRAM), static RAM (SRAM), cache RAM, and pseudo SRAM (PSRAM). For example, the non-volatile memory may include at least one of programmable ROM (PROM), erasable PROM (EPROM), electrically erasable PROM (EEPROM), flash memory, a hard disk, a compact disc, and an embedded multi-media card (eMMC). In an embodiment, the memory 415 may be referred to as a storage.

In an embodiment, the display 250 of the wearable device 201 may output visualized information to a user of the wearable device 201. The display 250 arranged in front of eyes of the user wearing the wearable device 201 may be disposed in at least a portion of a housing of the wearable device 201 (e.g., the first display 250-1 and/or the second display 250-2 of FIGS. 2A, 2B, 3A, and 3B). For example, the display 250 may be included in the display assembly. For example, the display 250 may output visualized information to the user by being controlled by the at least one processor 410 including a circuit such as a CPU, a graphics processing unit (GPU), and/or a display processing unit (DPU). The display 250 may include a flexible display, a flat panel display (FPD) and/or electronic paper. The display 250 may include a liquid crystal display (LCD), a plasma display panel (PDP), and/or one or more light emitting diode (LED). The LED may include an organic LED (OLED). The embodiment is not limited thereto, and for example, the display 250 may include a projector (or projection assembly) for projecting light onto the lens when the wearable device 201 includes a lens for transmitting external light (or ambient light). In an embodiment, the display 250 may be referred to as a display panel and/or a display module. Pixels included in the display 250 may be disposed toward any one of the user's two eyes when worn by the user of the wearable device 201. For example, the display 250 may include display areas (or active areas) corresponding to each of the user's two eyes.

In an embodiment, the one or more sensors 420 of the wearable device 201 may generate electronic information capable of being processed by the at least one processor 410 and/or the memory 415 from non-electronic information associated with the wearable device 201. For example, the one or more sensors 420 may include a global positioning system (GPS) sensor for detecting a geographic location of the wearable device 201. In addition to the GPS method, the one or more sensors 420 may generate information indicating a geographical location of the wearable device 201 based on a global navigation satellite system (GNSS), such as Galileo, or Beidou. The information may be stored in the memory 415, processed by the at least one processor 410, and/or transmitted to another electronic device distinct from the wearable device 201 via a communication circuit.

Referring to FIG. 4, the motion sensor 422 is illustrated as one example of one or more sensors 420 included in the wearable device 201. In an embodiment, the motion sensor 422 may output an electrical signal indicating gravitational accelerations, accelerations, and/or angular velocities of a plurality of axes (e.g., x-axis, y-axis, and z-axis) that are perpendicular to each other and are based on a designated origin within the wearable device 201 and/or the motion sensor 422. For example, the at least one processor 410 may repeatedly receive or obtain, from the motion sensor 422, sensor data including accelerations, angular velocities, and/or magnitudes of magnetic fields of the number of the plurality of axes based on a designated period (e.g., 1 millisecond). In an embodiment, the motion sensor 422 may be referred to as an inertial measurement unit (IMU). The one or more sensors 420 included in the wearable device 201 are not limited to the above description, and may include a grip sensor, a proximity sensor, a heart rate sensor, a fingerprint sensor, an illuminance sensor, and/or a ToF sensor. By using the motion sensor 422, the at least one processor 410 may detect a motion of the wearable device 201 (e.g., a motion of the wearable device 201 caused by a user wearing the wearable device 201).

The one or more cameras 430 may include one or more optical sensors (e.g., charged coupled device (CCD) sensors, complementary metal oxide semiconductor (CMOS) sensors) that generate electrical signals representing a color and/or brightness of light. The one or more cameras 430 may be referred to as image sensors. A plurality of optical sensors included in the one or more cameras 430 may be disposed in a form of a two-dimensional array. The one or more cameras 430 may obtain electrical signals of each of the plurality of optical sensors substantially simultaneously to generate two-dimensional frame data corresponding to light reaching the optical sensors of the two-dimensional array. For example, photo data captured by using the one or more cameras 430 may mean a two-dimensional frame data obtained from at least one of the one or more cameras 430. For example, video data captured by using the one or more cameras 430 may mean a sequence of a plurality of two-dimensional frame data obtained from at least one of the one or more cameras 430 according to a frame rate. The one or more cameras 430 may be disposed toward a direction in which the one or more cameras 430 receive light, and may further include a flash light for outputting light toward the direction.

In an embodiment, each of one or more cameras 430 in the wearable device 201 may be disposed toward different directions. The one or more cameras 430 may include the camera 260 of FIGS. 2A, 2B, 3A, and/or 3B. As described above with reference to FIGS. 2A, 2B, 3A, and/or 3B, the one or more cameras 430 may include a gaze tracking camera (e.g., the gaze tracking camera 260-1 of FIGS. 2B and 3A) configured to be arranged toward eyes of a user wearing the wearable device 201. The at least one processor 410 may identify a direction of the gaze of the user by using an image and/or a video obtained from the gaze tracking camera. The gaze tracking camera may include an infrared (IR) sensor. The gaze tracking camera may be referred to as an eye sensor and/or an eye tracker.

According to an embodiment, the one or more cameras 430 may include an outward camera. The outward camera may be disposed toward a front of a user wearing the wearable device 201 (e.g., a direction in which two eyes may face). For example, the one or more cameras 430 may include a plurality of outward cameras. The embodiments are not limited thereto, and the outward camera may be disposed toward an external space. By using an image and/or a video obtained from the outward camera, the at least one processor 410 may identify an external object. For example, the at least one processor 410 may identify a position, a shape, and/or a gesture (e.g., a hand gesture) of a hand of the user wearing the wearable device 201 based on an image and/or a video obtained from the outward camera. By using an image and/or a video of an external environment obtained from the outward camera, the at least one processor 410 may recognize or track one or more objects in the external environment.

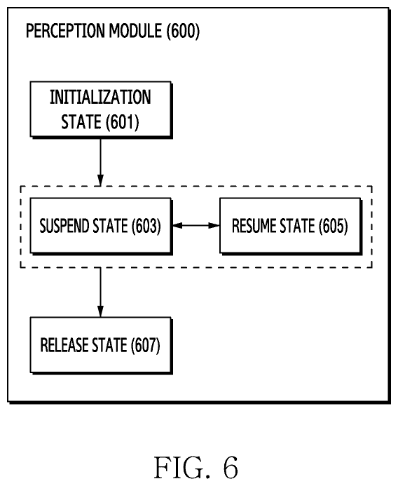

According to an embodiment, one or more instructions (or commands) indicating data to be processed by the at least one processor 410 of the wearable device 201, calculations and/or operations to be performed may be stored in the memory 415 of the wearable device 201. A set of one or more instructions may be referred to as a program, firmware, operating system, process, routine, sub-routine, and/or software application (hereinafter referred to as application). For example, the wearable device 201 and/or the at least one processor 410 may perform at least one of operations of FIGS. 6, 7, 8, 9, 10, 11A, 11B and 11C, when a set of a plurality of instruction distributed in the form of an operating system, firmware, driver, program, and/or software application is executed. Hereinafter, a software application being installed within the wearable device 201 may mean that one or more instructions provided in the form of a software application (or package) are stored in the memory 415, and that the one or more applications are stored in an executable format (e.g., a file with an extension designated by the operating system of the wearable device 201) by the at least one processor 410. As an example, the application may include a program and/or a library, associated with a service provided to a user.

Referring to FIG. 4, programs installed in the wearable device 201 may be included in any one among different layers including an application layer 440, a framework layer 450, and/or a hardware abstraction layer (HAL) 480, based on a target. For example, programs (e.g., module or driver) designed to target a hardware (e.g., the display 250, the one or more sensors 420, and/or the one or more camera 430) of the wearable device 201 may be included in the hardware abstraction layer 480 (e.g., android system HAL, and/or XR HAL). In terms of including one or more programs for providing an extended reality (XR) service, the framework layer 450 may be referred to as an XR framework layer. For example, the layers illustrated in FIG. 4, which are logically separated (or for convenience of explanation), may not mean that an address space of the memory 415 is divided by the layers.

Programs (e.g., head tracking perception module 471, scene perception module 472, hand tracking perception module 473, eye tracking perception module 474, face tracking perception module 475, and/or renderer 490) designed to target at least one of the hardware abstraction layer 480 and/or the application layer 440 may be included within framework layer 450. Programs included in the framework layer 450 may provide an application programming interface (API) capable of being executed (or called) based on other programs.

A program designed to target a user of the wearable device 201 may be included in the application layer 440. An extended reality (XR) system user interface (UI) 441 and/or an XR application 442 are illustrated as an example of programs included in the application layer 440, but embodiments are not limited thereto. For example, programs (e.g., software application) included in the application layer 440 may cause execution of a function supported by programs included in the framework layer 450, by calling the API.

The wearable device 201 may display, on the display 250, one or more visual objects for performing interaction with the user, based on the execution of the XR system UI 441. The visual object may mean an object capable of being positioned within a screen for transmission of information and/or interaction, such as text, image, icon, video, button, check box, radio button, text box, slider and/or table. The visual object may be referred to as a visual guide, a virtual object, a visual element, a UI element, a view object, and/or a view element. The wearable device 201 may provide functions available in a virtual space to the user, based on the execution of the XR system UI 441.

Referring to FIG. 4, it is described that the XR system UI 441 includes a lightweight renderer 443 and/or an XR plug-in 444 but is not limited thereto. For example, the at least one processor 410 may execute the lightweight renderer 443 and/or the XR plug-in 444 in the framework layer 450, based on the XR system UI 441.

The wearable device 201 may obtain a resource (e.g., API, system process, and/or library) used to define, create, and/or execute a rendering pipeline in which partial changes are allowed, based on the execution of the lightweight renderer 443. The lightweight renderer 443 may be referred to as a lightweight renderer pipeline in terms of defining a rendering pipeline in which partial changes are allowed. The lightweight renderer 443 may include a renderer (e.g., a prebuilt renderer) built before execution of a software application. For example, the wearable device 201 may obtain a resource (e.g., API, system process, and/or library) used to define, create, and/or execute the entire rendering pipeline, based on the execution of the XR plug-in 444. The XR plug-in 444 may be referred to as an open XR native client in terms of defining (or setting) the entire rendering pipeline.

The wearable device 201 may display a screen representing at least a portion of a virtual space on the display 250, based on the execution of the XR application 442. The XR plug-in 441-1 included in the XR application 442 may include instructions supporting a function similar to the XR plug-in 444 of the XR system UI 441. Among descriptions of the XR plug-in 441-1, a description overlapping those of the XR plug-in 444 may be omitted. The wearable device 201 may cause execution of a virtual space manager 451, based on execution of the XR application 442.

The wearable device 201 may display an image in a virtual space on the display 250, based on execution of an application 445. The application 445 may be configured to output image information for displaying a two-dimensional image. The wearable device 201 may cause execution of the virtual space manager 451, based on execution of the application 445. The wearable device 201 may create double image information to represent the two-dimensional image in a three-dimensional virtual space, based on the execution of the application 445. Herein, the double image information may include first image information for the left eye and second image information for the right eye, in consideration of binocular disparity. In order to represent the two-dimensional image in the three-dimensional virtual space, the wearable device 201 may create the double image information, based on image information for displaying the two-dimensional image.

According to an embodiment, the wearable device 201 may provide a virtual space service, based on the execution of the virtual space manager 451. For example, the virtual space manager 451 may include a platform for supporting a virtual space service. Based on the execution of the virtual space manager 451, the wearable device 201 may identify a virtual space formed based on a user's location indicated by data obtained through the one or more sensors 420 and/or an image obtained through the one or more cameras 430, and may display at least a portion of the virtual space on the display 250. The virtual space manager 451 may be referred to as a composition presentation manager (CPM).

The virtual space manager 451 may include a runtime service 452. As an example, the runtime service 452 may be referred to as an OpenXR runtime module (or OpenXR runtime program). The wearable device 201 may execute at least one of a user's pose prediction function, a frame timing function, and/or a space input function, based on the execution of the runtime service 452. As an example, the wearable device 201 may perform rendering for a virtual space service to a user, based on the execution of the runtime service 452. For example, based on the execution of runtime service 452, a function associated with a virtual space executable by the application layer 440 may be supported.

The virtual space manager 451 may include a pass-through manager 453. The wearable device 201 may display, while displaying a screen representing a virtual space on display 250, based on the execution of the pass-through manager 453, an image and/or a video representing an actual space obtained through an external camera superimposed on at least a portion of the screen.

The virtual space manager 451 may include an input manager 454. The wearable device 201 may identify data (e.g., sensor data) obtained by executing one or more programs included in a perception service layer 470, based on the execution of the input manager 454. The wearable device 201 may identify a user input associated with the wearable device 201, by using the obtained data. The user input may be associated with the user's motion (e.g., hand gesture), gaze, and/or speech identified by the one or more sensors 420 and/or the one or more cameras 430 (e.g., external camera). The user input may be identified based on an external electronic device connected (or paired) through a communication circuit.

A perception abstract layer 460 may be used for data exchange between the virtual space manager 451 and the perception service layer 470. In terms of being used for data exchange between the virtual space manager 451 and the perception service layer 470, the perception abstract layer 460 may be referred to as an interface. As an example, the perception abstraction layer 460 may be referred to as OpenPX. The perception abstraction layer 460 may be used for a perception client and a perception service.

According to an embodiment, the perception service layer 470 may include one or more programs for processing data obtained from the one or more sensors 420 and/or an image obtained through the one or more cameras 430. One or more programs may include at least one of the head tracking perception module 471, the scene perception module 472, the hand tracking perception module 473, the eye tracking perception module 474, the face tracking perception module 475, and/or renderer 490. The type and/or number of one or more programs included in the perception service layer 470 is not limited as illustrated in FIG. 4. For example, a body tracking perception module may be included in the perception service layer 470. The wearable device 201 may identify a body of a user wearing the wearable device 201 by using the one or more sensors 420 and/or the one or more cameras 430 based on the execution of the body tracking perception module.

The wearable device 201 may identify a posture of the wearable device 201 by using the one or more sensors 420 and/or the one or more cameras 430, based on the execution of the head tracking perception module 471. The wearable device 201 may identify 6 degrees of freedom pose (6 dof pose) of the wearable device 201, based on the execution of the head tracking perception module 471, by using data obtained using an external camera (e.g., the one or more cameras 430) and/or an IMU (e.g., motion sensor 422 including gyro sensor, acceleration sensor and/or geomagnetic sensor). The head tracking perception module 471 may be referred to as a head tracking (HeT) module (or a head tracker or head tracking program) and/or a position tracker.

For example, the wearable device 201 may obtain information for providing a three-dimensional virtual space corresponding to a surrounding environment (e.g., external space) of the wearable device 201 (or a user of the wearable device 201), based on the execution of the scene perception module 472. The wearable device 201 may reproduce the surrounding environment of the wearable device 201 in three dimensions, by using data obtained using an external camera (e.g., the one or more cameras 430) based on the execution of the scene perception module 472. The wearable device 201 may identify at least one of a plane, an inclination, and a step, based on the surrounding environment of the wearable device 201 reproduced in three dimensions based on the execution of the scene perception module 472. The scene perception module 472 may be referred to as a scene understanding (SU) module (or a scene recognition program) and/or a space recognizer.

For example, the wearable device 201 may identify (or recognize) a hand's pose and/or gesture of the user of the wearable device 201 based on the execution of hand tracking perception module 473. For example, the wearable device 201 may identify a pose and/or a gesture of the user's hand by using data obtained from an external camera (e.g., the one or more cameras 430), based on the execution of hand tracking perception module 473. As an example, the wearable device 201 may identify a pose and/or a gesture of the user's hand, based on data (or image) obtained using an external camera based on the execution of hand tracking perception module 473. Hand tracking perception module 473 may be referred to as a hand tracking (HaT) module (or a hand tracking program), a gesture tracker and/or a gesture tracking module.

The wearable device 201 may identify (or track) the movement of the user's eyes of the wearable device 201, based on the execution of the eye tracking perception module 474. For example, the wearable device 201 may identify the movement of the user's eyes, by using data obtained from a gaze tracking camera (e.g., the one or more cameras 430) based on the execution of the eye tracking perception module 474. The eye tracking perception module 474 may be referred to as an eye tracking (ET) module (or eye tracking program), a gaze tracker, and/or a gaze tracking module.

For example, the perception service layer 470 of the wearable device 201 may further include the face tracking perception module 475 for tracking the user's face. For example, the wearable device 201 may identify (or track) the movement of the user's face and/or the user's facial expression, based on the execution of the face tracking perception module 475. The wearable device 201 may estimate the user's facial expression, based on the movement of the user's face based on the execution of the face tracking perception module 475. For example, the wearable device 201 may identify the movement of the user's face and/or the user's facial expression, based on data (e.g., image and/or video) obtained using a FT camera (e.g., a camera facing at least a portion of the user's face) and/or the one or more cameras 430, based on the execution of the face tracking perception module 475. The face tracking perception module 475 may be referred to as a face tracking (FT) (or a face tracking program), a face tracker, and/or a face tracking module.

Referring to FIG. 4, a renderer 490 may include instructions for rendering images in a three-dimensional virtual space. The at least one processor 410 (e.g., DPU) executing the renderer 490 may obtain at least one image to be at least partially displayed on a display area of the display 250 at a software application (e.g., software application executed by CPU and/or GPU). For example, the at least one processor 410 executing the renderer 490 may determine a location of an area to which an application (e.g., XR application 442, application 445) is to be rendered. The at least one processor 410 executing the renderer 490 may create an image of the application to be displayed on the display 250. The renderer 490 may synthesize the images to create a composite image to be displayed on the display 250.

The at least one processor 410 executing the renderer 490 may divide a display area of the display 250 into a foveated portion (or may be referred to as a foveated area) and a peripheral portion (or may be referred to as a remaining area), by using a gaze location calculated using the head tracking perception module 471 and/or the eye tracking perception module 474. For example, the at least one processor 410 detecting coordinate values of the gaze location may determine a portion of the display area including the coordinate values as a foveated area. The DPU (e.g., at least one processor 410) executing the renderer 490 may obtain at least one image, corresponding to each of the foveated area and the remaining area, and having a size smaller than a size of the entire display area of the display 250 or a resolution less than a resolution of the display area.

The at least one processor 410 executing the renderer 490 may obtain or create a composite image to be displayed on the display 250, by synthesizing an image corresponding to the foveated area and an image corresponding to a peripheral portion. For example, the at least one processor 410 may enlarge the image corresponding to the peripheral portion to a size of the entire display area of the display 250, by performing upscaling. The at least one processor 410 may create a composite image to be displayed on the display 250, by combine the image corresponding to the foveated area onto the enlarged image. The at least one processor 410 may mix the enlarged image and the image corresponding to the foveated area, by applying a visual effect such as blur along a boundary line of the image corresponding to the foveated area.

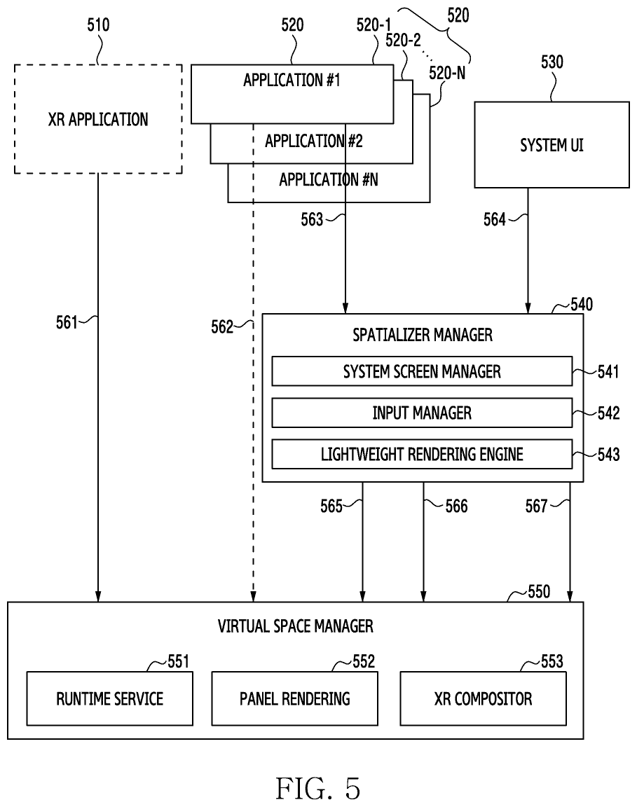

FIG. 5 illustrates an example of a block diagram of an electronic device for displaying an image in a virtual space according to an embodiment of the disclosure. The electronic device (e.g., the electronic device 101) of FIG. 5 may include the wearable device 201.

Referring to FIG. 5, an example in which a plurality of programs (or instructions) for displaying an image in a virtual space is executed is described. The plurality of programs (or instructions) may all be executed in one processor (e.g., AP) or may be executed by a plurality of processors (e.g., AP, graphics processing unit (GPU), neural processing unit (NPU)). The meaning of being executable by the plurality of processors may indicate that a portion of programs (or instructions) may be executed by a first processor and another portion of programs (or instructions) may be executed by a second processor different from the first processor.

Referring to FIG. 5, the electronic device 101 may execute a virtual space manager 550 (e.g., the virtual space manager 451 and the CPM of FIG. 4) to render an image in a virtual space. For the virtual space manager 550, descriptions of the virtual space manager 451 of FIG. 4 may be at least partially referenced. The virtual space manager 550 may include a platform for supporting a virtual space service. The virtual space manager 550 may include a runtime service 551 (e.g., OpenXR Runtime), a panel rendering 552 (e.g., two-dimensional (2D) Panel Render), and an XR compositor 553. The electronic device 101 may execute at least one of a user's pose prediction function, a frame timing function, and/or a space input function, based on the execution of the runtime service 551. For the runtime service 551, descriptions of the runtime service 452 of FIG. 4 may be at least partially referenced. The electronic device 101 may display at least one image (video) on a panel (e.g., a 2D panel) to implement a virtual space through the display 250, based on the execution of the panel rendering 552. For example, the electronic device 101 may display a rendering image corresponding to RGB information 566 for a panel from a spatialization manager 540 to be described later via a display (e.g., display 250). The electronic device 101 may synthesize an image of an actual area captured through a camera in a virtual space (hereinafter, a pass-through image) and a virtual area image, based on the execution of the XR compositor 553. For example, the electronic device 101 may create a composite image, by merging the pass-through image and the virtual area image, based on the execution of the XR compositor 553. The electronic device 101 may transmit the created composite image to a display buffer so that the composite image is displayed. The electronic device 101 may identify the virtual space through the virtual space manager 550, and display at least a portion of the virtual space on the display 250. The virtual space manager 550 may be referred to as the CPM. The electronic device 101 may execute the virtual space manager 550 to render an image corresponding to at least a portion of the virtual space.

According to an embodiment, the electronic device 101 may execute the spatialization manager 540. The spatialization manager 540 may perform processes for displaying an image in a three-dimensional virtual space. The electronic device 101 may perform preprocessing based on the execution of the spatialization manager 540 so that an image may be rendered in a three-dimensional virtual space through the virtual space manager 550. For example, the electronic device 101 may perform at least some of functions of the renderer 490 of FIG. 4, based on the execution of the spatialization manager 540. Based on the execution of the spatialization manager 540, the electronic device 101 may process image information provided by an application (e.g., the XR application 510, an application 520 providing a normal two-dimensional screen other than XR, and an application that provides a system UI 530). The spatialization manager 540 (e.g., Space Flinger) may include a system screen manager 541 (e.g., System scene), an input manager 542 (e.g., Input Routing), and a lightweight rendering engine 543 (e.g., Impress Engine). The system screen manager 541 may be executed to display the system UI 530. System UI-related information 564 may be transmitted from a program (e.g., API) providing the system UI 530 to the system screen manager 541. The system UI-related information 564 may be obtained via a spatializer API and/or a Same-process private API. The spatialization manager 540 may determine a layout (e.g., location, display order) of a screen of the system UI 530 in a three-dimensional space, through pre-allocated resources. The system screen manager 541 may transmit image information 567 for rendering a screen of the system UI 530 to the virtual space manager 550, according to the layout. The input manager 542 may be configured to process a user input (e.g., user input on a system screen or an app screen). The input manager 542 may map a user input recognized by the one or more sensors 420 and/or the one or more cameras 430 of the electronic device 101 to at least one of one or more software applications (e.g., the XR application 510, the application 520 providing a general 2D screen that is not XR, the application providing a system UI 530) mapped to a virtual space by the spatialization manager 540. For example, a mapping of the user input may include an operation of executing instructions (e.g., sub routine and/or event handler) of a software application for processing the user input. The lightweight rendering engine 543 may be a renderer (e.g., the lightweight renderer 443) for image generation. For example, the lightweight rendering engine 543 may be used to display the system UI 530.

According to an embodiment, the spatialization manager 540 may include the lightweight rendering engine 543 for rendering a system UI. According to an embodiment, when the lightweight rendering engine 543 does not have sufficient resources to render an avatar used in an HMD, at least one external rendering engine may be used. In this case, in order to solve a compatibility issue with external rendering (e.g., a third-party engine), an external rendering engine support module may be added inside the spatialization manager 540.

According to an embodiment, the electronic device may execute an application. For example, the virtual space manager 550 may be executed in response to the execution of the XR application 510 (e.g., the XR application 442, 3D game, XR map, and other immersive application). The electronic device 101 may provide the virtual space manager 550 with double image information 561 provided from the XR application 510. In order to display an image in a three-dimensional space, the double image information 561 may include two image information considering binocular disparity. For example, the double image information 561 may include first image information for the user's left eye and second image information for the user's right eye for rendering in a three-dimensional virtual space. Hereinafter, in the disclosure, double image information is used as a term referring to image information for indicating images for two eyes in a three-dimensional space. In addition to the double image information, binocular image information, double image data, double image, binocular image data, stereoscopic image information, 3D image information, spatial image information, spatial image data, 2D-3D conversion data, dimensional conversion image data, binocular disparity image data, and/or equivalent technical terms may be used. The electronic device 101 may create a composite image by merging image layers via the virtual space manager 550. The electronic device 101 may transmit the created composite image to a display buffer. The composite image may be displayed on the display 250 of the electronic device 101.

According to an embodiment, the electronic device may execute at least one of an application 520 (e.g., first application 520-1, second application 520-2, . . . , and Nth application 520-N) different from the XR application 510. According to an embodiment, the application 520 may be configured to output image information for displaying a two-dimensional image. In other words, the application 520 may provide a 2D image (e.g. window, and/or activity). As an example, the application 520 may be an image application, a schedule application, or an Internet browser application. If, in response to the execution of the application 520, assume that image information 562 provided from the application 520 is provided to the virtual space manager 550. Since the image information 562 has only the x-coordinate and y-coordinate in the two-dimensional plane, it may be difficult to consider the order of precedence (i.e., a distance separated from the user) between other applications centered on the user. Even when displaying the application 520 providing a general 2D screen, the electronic device 101 may execute the spatialization manager 540 to provide double image information to the virtual space manager 550. For example, the electronic device 101 may receive application-related information 563 from the first application 520-1, based on the execution of the spatialization manager 540. For example, the application-related information 563 may include image information (e.g., information including red green blue (RGB) per pixel) indicating a two-dimensional image of the first application 520-1 and/or content information (e.g., characteristic of content executed in the first application, type of content) in the first application 520-1. The application-related information 563 may be obtained through a spatializer API. Based on the execution of the spatialization manager 540, the electronic device 101 may identify a location of an area in which the first application 520-1 is to be rendered and information (hereinafter, location information) on a size of the area to be rendered. Based on the execution of the spatialization manager 540, the electronic device 101 may create double image information 565 (e.g., RGBx2) in which the user's binocular disparity is considered, through the image information and the location information. Based on the execution of the spatialization manager 540, the electronic device 101 may provide the double image information 565 to the virtual space manager 550. By converting a simple two-dimensional image into the double image information 565, a problem occurring when the image information 562 is directly transmitted to the virtual space manager 550 may be solved. In addition, as at least some of functions for image display in a virtual space are performed by the spatialization manager 540 instead of the virtual space manager 550, the burden on the virtual space manager 550 may be reduced.

FIG. 6 illustrates an example of an operation state of a perception module according to an embodiment of the disclosure. A perception module 600 may be referred to as a program stored in memory (e.g., the memory 415) of a wearable device (e.g., the wearable device 201). The perception module 600 may be included in the perception service layer 470 of FIG. 4. For example, the perception module 600 may be one of a head tracking perception module 471, a scene perception module 472, a hand tracking perception module 473, an eye tracking perception module 474, and a face tracking perception module 475. For example, the perception module 600 may be referred to as a perception solution. For example, the operation state of the perception module 600 may be referred to as a lifecycle of the perception module 600.

The wearable device 201 may obtain or generate perception data according to the perception module 600 based on an execution of the perception module 600. For example, the wearable device 201 may obtain or generate the perception data by executing or operating a process in the perception module 600 in a runtime environment. The perception module 600 may have the operation state. For example, according to the operation state of the perception module 600, another process for generating the perception data may be executed. For example, the operation state of the perception module 600 may be referred to as a step-by-step execution process of the perception module 600 executed in the wearable device 201.

Referring to FIG. 6, the operation state of the perception module 600 may include an initialization state 601, a suspend state 603, a resume state 605, and/or a release state 607. For example, the operation state of the perception module 600 may be changed or transitioned between the initialization state 601, the suspend state 603, the resume state 605, and the release state 607. For example, the change in the operation state of the perception module 600 may be controlled according to a signal provided from one or more conditions and/or other components.

The initialization state 601 may be referred to as a state in which the perception module 600 is loaded into the memory (e.g., the memory 415) of the wearable device 201. For example, as the wearable device 201 is activated, the operation state of the perception module 600 may be changed to the initialization state 601. For example, as the wearable device 201 performs booting, the operation state of the perception module 600 may be changed to the initialization state 601. For example, as the operation state of the perception module 600 is changed to the initialization state 601, a system resource may be allocated to the perception module 600. For example, as the operation state of the perception module 600 is changed to the initialization state 601, initialization of the system resource to be utilized by the perception module 600 may be performed. The initialization state 601 may be referred to as a create state.

The suspend state 603 may be referred to as a state in which the perception module 600 stands by to execute a process for generating the perception data. For example, as the execution of the process of the initialization state 601 is completed, the operation state of the perception module 600 may be changed to the suspend state 603. For example, in a case that the execution of the process in the initialization state 601 is completed and an execution condition of the process for obtaining the perception data is not satisfied, the operation state of the perception module 600 may be changed from the initialization state 601 to the suspend state 603. For example, the suspend state 603 may be referred to as a state that does not satisfy the execution condition of the process for obtaining the perception data. While the operation state of the perception module 600 is the suspend state 603, the execution of the process of generating the perception data in the perception module 600 may be suspended. For example, the suspend state 603 may be referred to as a standby state.

According to an embodiment, the wearable device 201 may change the operation state of the perception module 600 from the suspend state 603 to the resume state 605. For example, the wearable device 201 may change the operation state of the perception module 600 from the suspend state 603 to the resume state 605 in response to detecting an event that satisfies the execution condition of the process for obtaining the perception data while the operation state of the perception module 600 is the suspend state 603.

The resume state 605 may be referred to as a state in which the perception module 600 executes the process for generating the perception data. For example, as the execution of the process of the initialization state 601 is completed, the operation state of the perception module 600 may be changed to the resume state 605. For example, in a case that the execution of the process in the initialization state 601 is completed and the execution condition of the process for obtaining the perception data is satisfied, the operation state of the perception module 600 may be changed from the initialization state 601 to the resume state 605. For example, the resume state 605 may be referred to as a state that satisfies the execution condition of the process for obtaining the perception data.

While the operation state of the perception module 600 is the resume state 605, the process of generating the perception data in the perception module 600 may be executed. For example, while the operation state of the perception module 600 is the resume state 605, a command for generating the perception data may be executed or performed in the perception module 600. For example, while the operation state of the perception module 600 is the resume state 605, the perception module 600 may generate the perception data by performing a calculation for generating the perception data. For example, while the operation state of the perception module 600 is the resume state 605, the perception module 600 may process data inputted to the perception module 600. For example, the perception module 600 may generate the perception data by processing the data. For example, the resume state 605 may be referred to as an execution state.

According to an embodiment, the wearable device 201 may change the operation state of the perception module 600 from the resume state 605 to the suspend state 603. For example, the wearable device 201 may change the operation state of the perception module 600 from the resume state 605 to the suspend state 603 in response to detecting an event that fails to satisfy the execution condition of the process for obtaining the perception data while the operation state of the perception module 600 is the resume state 605.

The release state 607 may be referred to as a state in which the perception module 600 loaded into the memory of the wearable device 201 is released. The release state 607 may indicate that the execution of the process for generating the perception data is ended. For example, as the operation state of the perception module 600 is changed to the release state 607, the system resource utilized by the perception module 600 may be returned. For example, as the perception data is generated by the perception module 600, the operation state of the perception module 600 may be changed to the release state 607. As a non-limiting example, the operation state of the perception module 600 may be changed to the release state 607 according to a command (or a control signal) of the wearable device 201. For example, the release state may be referred to as an end state and/or a destroy state.

According to an embodiment, a change in an operation state of each of the perception modules (e.g., the head tracking perception module 471, the scene perception module 472, the hand tracking perception module 473, the eye tracking perception module 474, and the face tracking perception module 475) may be controlled through a service in each perception module. According to an embodiment, an allocation of the system resource utilized by each of the perception modules may be controlled through the service in each perception module. For example, independently of an operation state of another perception module, the service in each perception module may control a change in the operation state of each perception module. For example, the control of the change in the operation state of each perception module and/or the control of the allocation of the system resource utilized by each perception module may be performed through the service in each perception module, independently of the operation state of the other perception module. As the control of the operation state of each perception module and/or the control of the allocation of the system resource utilized by each perception module are performed independently of the operation state of the other perception module, an amount of a signal (or a request) transmitted between components in the wearable device (e.g., the wearable device 201) may be relatively large. For example, an amount of a calculation performed by at least one processor (e.g., at least one processor 410) of the wearable device 201 may be relatively large. As the amount of the calculation performed by the at least one processor increases, a quality of a function (e.g., a function of displaying an image representing a virtual space and a pass-through function) provided by the wearable device 201 may be reduced. There is a need for a method for reducing the amount of the calculation performed by the at least one processor 410.

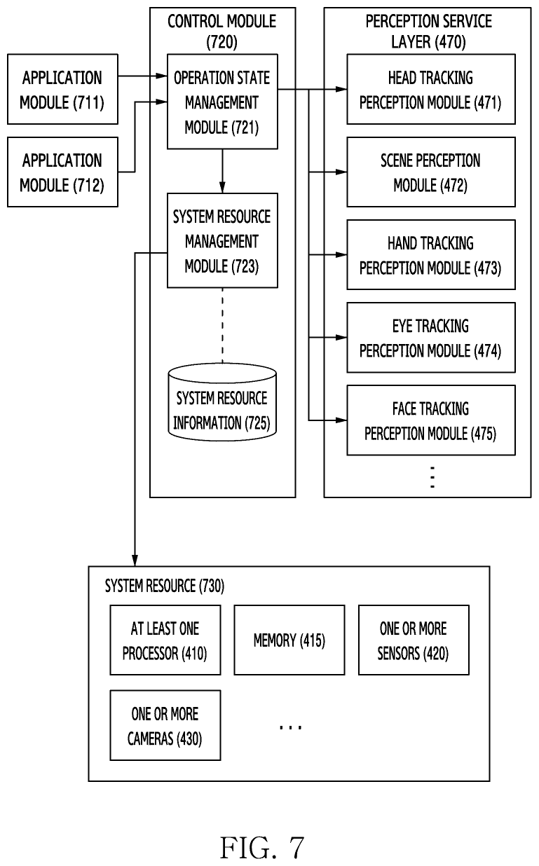

In the disclosure, components for controlling the operation state of each of the perception modules (e.g., the head tracking perception module 471, the scene perception module 472, the hand tracking perception module 473, the eye tracking perception module 474, and the face tracking perception module 475) in the wearable device 201 are described. For example, the component may include a control module (e.g., a control module 720) exemplified in FIG. 7. The control module may control a change in the operation state of each of the perception modules in the wearable device 201. For example, the control module may control a change in the operation state of each perception module according to the operation state of the other perception module. The control module may control the allocation of the system resource utilized by each of the perception modules. For example, the control module may control the allocation of the system resource utilized by each perception module according to the operation state of the other perception module. For example, as the control module performs processing for each perception module according to the operation state of the other perception module, the amount of the signal (or the request) transmitted between the components in the wearable device 201 may be decreased. For example, an amount of a signal for an overlapping service (or function) may be decreased. For example, the amount of the calculation performed by at least one processor (e.g., the at least one processor 410) of the wearable device 201 may be relatively small. For example, an amount of a calculation in a case that the processing for each perception module is processed according to the operation state of the other perception module may be smaller than an amount of a calculation in a case that the processing for each perception module is processed independently of the operation state of the other perception module. For example, as the amount of the calculation performed by the at least one processor is decreased, the quality of the function (e.g., displaying the image representing the virtual space and the pass-through function) provided by the wearable device 201 may be improved. A control module for processing each perception module according to the operation state of the other perception module will be described and exemplified with reference to FIG. 7.

FIG. 7 illustrates an example of a control module that controls a system resource utilized to obtain perception data according to an embodiment of the disclosure. Components exemplified in FIG. 7 may be included in a head-wearable electronic device. For example, the head-wearable electronic device may be an example of a wearable device (e.g., the wearable device 201). For example, operations performed in FIG. 7 may be executed, performed, or controlled by at least one processor (e.g., the at least one processor 410) of the head-wearable electronic device.

Referring to FIG. 7, the head-wearable electronic device may include application modules 711 and 712, a control module 720, a perception service layer 470, and/or a system resource 730. However, an embodiment is not limited thereto. A module in the head-wearable electronic device is not limited to an embodiment, and at least one module may perform an operation by being integrated or further including an additional module, and the at least one module may be implemented as hardware or software.

An application module 711 may be referred to as a module for providing a function in a head-wearable electronic device using the perception data. For example, the perception data may be used as the function provided by the head-wearable electronic device. For example, the application module 711 may provide the perception data with a function based on performing processing according to the function. For example, the function provided by the head-wearable electronic device may include a function to display an image representing a virtual space, a pass-through function, an eye tracking function, a gesture perception function, a hand tracking function, a face tracking function, a head tracking function, a space perception function, and/or an object tracking function, but an embodiment is not limited thereto. For example, the application module 711 may receive the perception data from a perception module in the perception service layer 470. For example, the perception module may be one or more of a head tracking perception module 471, a scene perception module 472, a hand tracking perception module 473, an eye tracking perception module 474, and a face tracking perception module 475.

For convenience of description in the disclosure, a perception module for generating or obtaining requested perception data may be referred to as a target perception module. That is, in a case that the application module 711 requests perception data associated with eye tracking, the eye tracking perception module 474 may be referred to as the target perception module. For example, in a case that the application module 711 requests perception data associated with face perception, the face tracking perception module 475 may be referred to as the target perception module. As a non-limiting example, the target perception module may include a plurality of perception modules.

The application module 711 may request the perception data. The application module 711 may request the control module 720 to control the target perception module to obtain the perception data. For example, the head-wearable electronic device may request the control module 720 to control the target perception module using the application module 711 according to a user input. For example, the control of the target perception module may include control that causes the target perception module to generate the perception data. For example, the control of the target perception module may include control for receiving the perception data from the target perception module. As a non-limiting example, as the obtaining of the requested perception data is completed, the application module 711 may request the control module 720 to control the target perception module. For example, the control of the target perception module may include control for the target perception module to suspend or refrain from providing the perception data to the application module 711. For example, the control of the target perception module may include control for the target perception module to suspend or refrain from generating the perception data for the application module 711.

According to an embodiment, the application module 711 may transmit or provide a request signal for receiving the perception data from the target perception module to the control module 720. The application module 711 may deliver, transmit, or provide timing information associated with the perception data to the control module 720. For example, the timing information associated with the perception data may indicate a start point of the perception data required by the application module 711 and/or an end point of the perception data required by the application module 711.

The application module 712 may be referred to as the module for providing the function in the head-wearable electronic device using the perception data. Since the application module 712 may be substantially the same as the application module 711, a redundant description will be omitted for convenience of description. For example, the function provided by the application module 712 may be different from the function provided by the application module 711. Each of the application modules 711 and 712 may be referred to as a client and/or an external user.

The control module 720 may be used to change an operation state of perception modules in the perception service layer 470. In addition, the control module 720 may be used to control allocation of the system resource 730 utilized by each of the perception modules. For example, the control module 720 may include an operation state management module 721, a system resource management module 723, and/or system resource information 725. For example, the control module 720 may be referred to as a perception lifecycle management service.

The operation state management module 721 may be used to manage the operation state of the perception modules. For example, the operation state management module 721 may be referred to as a perception lifecycle manager. For example, information indicating the operation state of the perception modules may be included, stored, or retained in the operation state management module 721. For example, information indicating an application module connected to each perception module may be included, stored, or retained in the operation state management module 721. For example, information indicating an application module requiring the perception data generated from each perception module may be included, stored, or retained in the operation state management module 721.

The operation state management module 721 may receive the request for control of the perception module (or a request for change in the operation state) from one or more of the application modules 711 and 712. For example, the operation state management module 721 may identify an operation state of each of the perception modules in response to the request. For example, the operation state management module 721 may determine whether to change the operation state of the target perception module for generating the perception data corresponding to the request according to the operation state of each of the perception modules.

According to an embodiment, the operation state management module 721 may request the target perception module to change the operation state of the target perception module in a case that the operation state of the target perception module is a suspend state (e.g., the suspend state 603) according to a request for obtaining the perception data. For example, the operation state management module 721 may request the target perception module to change the operation state of the target perception module from the suspend state to a resume state (e.g., the resume state 605). For example, the head-wearable electronic device may change the operation state of the target perception module from the suspend state to the resume state using the operation state management module 721.

According to an embodiment, the operation state management module 721 may determine to maintain the operation state of the target perception module as the resume state in a case that the operation state of the target perception module is the resume state according to the request for obtaining the perception data. For example, the operation state management module 721 may refrain from, bypass, or skip requesting the target perception module to change the operation state of the target perception module. For example, the operation state management module 721 may not request the target perception module to change the operation state of the target perception module. For example, the operation state management module 721 may refrain from, bypass, or skip performing a calculation of requesting the target perception module to change the operation state of the target perception module. For example, the operation state management module 721 may not perform the calculation of requesting the target perception module to change the operation state of the target perception module. For example, the head-wearable electronic device may maintain the operation state of the target perception module as the resume state by using the operation state management module 721.

According to an embodiment, the operation state management module 721 may identify whether there is at least one application module for receiving the perception data generated from the target perception module according to a request for suspending the provision of the perception data. For example, the operation state management module 721 may determine to maintain the operation state of the target perception module as the resume state according to identifying the at least one application module that receives the perception data generated from the target perception module. For example, the operation state management module 721 may refrain from, bypass, or skip requesting the target perception module to change the operation state of the target perception module. For example, the operation state management module 721 may not request the target perception module to change the operation state of the target perception module. For example, the operation state management module 721 may refrain from, bypass, or skip performing the calculation of requesting the target perception module to change the operation state of the target perception module. For example, the operation state management module 721 may not perform the calculation of requesting the target perception module to change the operation state of the target perception module. For example, the head-wearable electronic device may maintain the operation state of the target perception module as the resume state by using the operation state management module 721.

The operation state management module 721 may request the target perception module to change the operation state of the target perception module according to identifying that the at least one application module receiving the perception data generated from the target perception module is not present. For example, the operation state management module 721 may request the target perception module to change the operation state of the target perception module from the resume state to the suspend state. For example, the head-wearable electronic device may change the operation state of the target perception module from the resume state to the suspend state by using the operation state management module 721.

According to an embodiment, the operation state management module 721 may change the operation state of the target perception module and/or an operation state of another perception module according to an association relationship (or a dependent relationship) between the target perception module and the other perception module. For example, the target perception module may be the hand tracking perception module 473. For example, there may be an association relationship between the hand tracking perception module 473 and the head tracking perception module 471. For example, the association relationship may indicate that the operation state of the head tracking perception module 471 is changed from the suspend state to the resume state as the operation state of the hand tracking perception module 473 is changed from the suspend state to the resume state. For example, the operation state management module 721 may determine to change the operation state of the head tracking perception module 471 from the suspend state to the resume state by determining to change the operation state of the hand tracking perception module 473 from the suspend state to the resume state.

According to an embodiment, the operation state management module 721 may request the system resource management module 723 to control the allocation of the system resource 730 in response to identifying the operation state of each of the perception modules. For example, the operation state management module 721 may transmit or provide the system resource management module 723 with a request signal for controlling the allocation of the system resource 730.

The system resource management module 723 may be referred to as a module for managing the system resource 730 utilized by each perception module. For example, the system resource management module 723 may be referred to as a system resource manager. The system resource management module 723 may perform the allocation of the system resource 730 based on the operation state of each of the perception modules and/or the system resource information 725.

The system resource management module 723 may receive the request associated with the allocation of the system resource 730 from the operation state management module 721. For example, the system resource management module 723 may control the allocation of the system resource 730 in response to the request. For example, the system resource management module 723 may control the allocation of the system resource 730 according to the operation state of each of the perception modules.

The system resource information 725 may include information indicating the system resource 730 required by each perception module. For example, the system resource information 725 may include information indicating the system resource 730 utilized by each perception module while the operating state of each perception module is the resume state (e.g., the resume state 605). For example, the system resource information 725 may indicate a camera utilized by each perception module among one or more cameras 430. For example, the system resource information 725 may indicate a camera setting of the camera utilized by each perception module. For example, the system resource information 725 may indicate a scheduling priority level of each perception module. For example, in a case that each perception module (or a task of each perception module) is processed (or executed) by the at least one processor (e.g., an NPU), the scheduling priority level may be referred to in an order in which each perception module (or the task of each perception module) is processed by the at least one processor. For example, the scheduling priority level may be determined by a user of the head-wearable electronic device. For example, a scheduling priority level of the head tracking perception module 471 may be set higher than a scheduling priority level of other perception modules. However, an embodiment is not limited thereto. As a non-limiting example, the scheduling priority level may be determined according to the application module (e.g., the application modules 711 and 712) running on the head-wearable electronic device. For example, in a case that the application module 711 running on the head-wearable electronic device includes a service associated with iris recognition, a scheduling priority level of the eye tracking perception module 474 may be set higher than the scheduling priority level of the other perception modules.

The system resource management module 723 may control or manage the allocation of the system resource 730 based on the operation state of each of the perception modules and/or the system resource information 725. The system resource 730 may be referred to as a hardware resource and/or a software resource utilized for the perception modules. The system resource 730 may include the at least one processor 410, memory 415, one or more sensors 420, and/or the one or more cameras 430, but an embodiment is not limited thereto.

According to an embodiment, the system resource management module 723 may perform pre-allocation for the system resource 730 to the perception module based on the operation state of each of the perception modules. For example, the system resource management module 723 may allocate an amount of the memory 415 to each perception module before receiving the request for the perception data. For example, the system resource management module 723 may determine in advance the amount of the memory 415 to be utilized by each perception module as the operation state of each perception module is changed to the resume state. For example, the system resource management module 723 may preempt the amount of the memory 415 according to the operation state of each of the perception modules. As a non-limiting example, the system resource management module 723 may determine in advance the amount of the memory 415 to be utilized by each perception module such that one or more of the perception modules share the amount of the memory 415.

According to an embodiment, the system resource management module 723 may perform control for the allocation of the system resource 730 according to a process determined according to a predetermined rule (or policy). However, an embodiment is not limited thereto. For example, the system resource management module 723 may change or redefine the predetermined rule (or policy) based on identifying a relationship between the system resource 730 and the perception modules. In addition, as a non-limiting example, the operation state management module 721 may perform controlling for the change in the operation state of each perception module according to the process determined according to the predetermined rule (or policy). For example, the system resource management module 723 may change or redefine the predetermined rule (or policy) based on identifying the relationship between the system resource 730 and the perception modules.

In the disclosure, the change in the operation state of the perception modules may be controlled by the control module 720 different from the perception modules according to the operation state of each of the perception modules. In addition, the allocation of the system resource 730 utilized by each perception module may be controlled by the control module 720 different from the perception modules according to the operation state of each of the perception modules. As the change in the operation state of the perception modules is controlled according to the operation state of each of the perception modules by the control module 720, the head-wearable electronic device may efficiently process requests provided from a plurality of application modules 711 and 712. As the allocation of the system resource 730 utilized by each perception module is controlled by the control module 720 according to the operation state of each of the perception modules, the head-wearable electronic device may efficiently process the requests provided from the plurality of application modules 711 and 712. For example, an amount of a signal (e.g., a request to change the operation state of the same perception module from the suspend state to the resume state and an activation control signal to activate the camera) for an overlapping service (or function) in the head-wearable electronic device may be decreased. For example, the number of times of overwriting of a signal for the same service may be decreased. For example, an amount of an overlapping calculation performed in the head-wearable electronic device may be decreased. For example, a quality of a function provided in the head-wearable electronic device according to the perception data may be enhanced. For example, a latency in an extended reality (XR) (or virtual reality (VR), or augmented reality (AR), or mixed reality (MR)) function provided by the head-wearable electronic device may decrease.

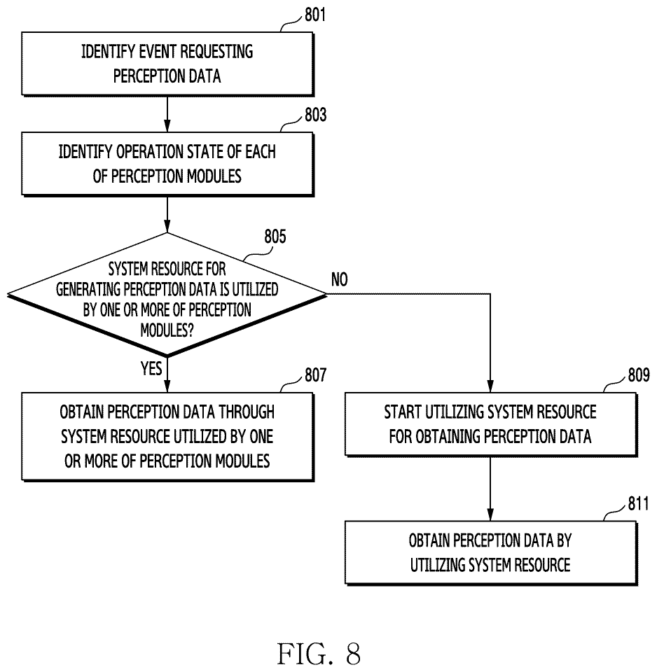

FIG. 8 illustrates an example of operations of a head-wearable electronic device for obtaining perception data according to an embodiment of the disclosure. The operations exemplified in FIG. 8 may be performed in the head-wearable electronic device. For example, the head-wearable electronic device may be an example of a wearable device 201 and/or an electronic device 101. For example, the operations of the head-wearable electronic device may be executed, performed, or controlled by at least one processor (e.g., the at least one processor 410).

Referring to FIG. 8, in operation 801, the head-wearable electronic device may identify an event requesting the perception data. For example, the perception data may be generated by utilizing a system resource (e.g., the system resource 730). For example, the event requesting the perception data may include an application module (e.g., the application modules 711 and 712) providing a function of using the perception data in the head-wearable electronic device. For example, the event requesting the perception data may include receiving a user input while the application module is running on the head-wearable electronic device. For example, based on identifying the event requesting the perception data, the head-wearable electronic device may request the perception data to a control module (e.g., the control module 720) by using the application module.

In operation 803, the head-wearable electronic device may identify an operation state of each of perception modules. For example, the operation 803 may be executed based on the operation 801. For example, the perception modules may be included in the head-wearable electronic device. For example, each of the perception modules may be available in the head-wearable electronic device. For example, the perception module may be one or more of the head tracking perception module 471, the scene perception module 472, the hand tracking perception module 473, the eye tracking perception module 474, and the face tracking perception module 475 of FIG. 4. For example, descriptions of FIG. 6 may be referred to for the operation state of the perception module.

The head-wearable electronic device may identify the operation state of each of the perception modules by using the control module (e.g., the control module 720). For example, the control module may be different from the perception modules. For example, the control module may be distinguished from the perception modules. However, an embodiment is not limited thereto. For the control module, descriptions of the control module 720 of FIG. 7 may be referred to.

The head-wearable electronic device may identify the operation state of each of the perception modules using an operation state management module (e.g., the operation state management module 721) in the control module. Descriptions of the operation state management module 721 of FIG. 7 may be referred to for the operation state management module.

In operation 805, the head-wearable electronic device may identify whether the system resource for generating the perception data is utilized by one or more of the perception modules in accordance with the identified operation state of each of the perception modules. For example, the head-wearable electronic device may execute operation 807 based on identifying that the system resource for generating the perception data is utilized by the one or more of the perception modules in accordance with the identified operation state of each of the perception modules (the operation 805—YES). For example, the head-wearable electronic device may execute operation 809 and/or operation 811 based on identifying that the system resource for generating the perception data is not utilized by the perception modules in accordance with the identified operation state of each of the perception modules (the operation 805—NO).

In operation 807, the head-wearable electronic device may obtain the perception data through the system resource utilized by the one or more of the perception modules. For example, the head-wearable electronic device may utilize the system resource utilized by the one or more of the perception modules to obtain the perception data. For example, the head-wearable electronic device may maintain the utilization of the system resource utilized by the one or more of the perception modules.

According to an embodiment, the head-wearable electronic device may maintain a state of the system resource as an activation state based on identifying that the system resource (e.g., the one or more sensors 420 and the one or more cameras 430) for generating the perception data is utilized by the one or more of the perception modules. For example, the head-wearable electronic device may refrain from or bypass transmitting an activation control signal for activating the state of the system resource to the system resource. For example, the head-wearable electronic device may not transmit the activation control signal for activating the state of the system resource to the system resource. For example, the head-wearable electronic device may refrain from or bypass performing a calculation for activating the state of the system resource. For example, the head-wearable electronic device may not perform the calculation for activating the state of the system resource.

In operation 809, the head-wearable electronic device may start utilizing the system resource for obtaining the perception data, by using the control module. For example, the head-wearable electronic device may perform allocation of the system resource to obtain the perception data using a system resource management module (e.g., the system resource management module 723) in the control module. For example, the head-wearable electronic device may transmit, provide, or deliver the activation control signal to the system resource for obtaining the perception data by using the control module. For example, the activation control signal may be referred to as a signal for activating the state of the system resource.

In operation 811, the head-wearable electronic device may obtain the perception data by utilizing the system resource for obtaining the perception data. For example, the application module may obtain the perception data. For example, the head-wearable electronic device may provide a function associated with an XR (or a VR, or an AR, or an MR) using the obtained perception data.

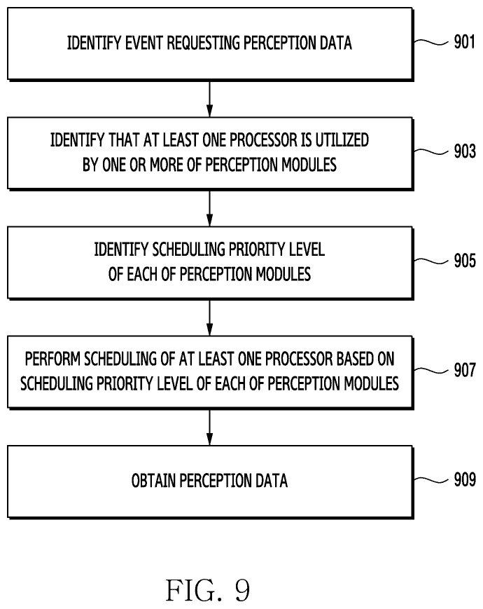

FIG. 9 illustrates an example of operations of a head-wearable electronic device that obtains perception data by performing scheduling of at least one processor according to an embodiment of the disclosure. The operations exemplified in FIG. 9 may be performed in the head-wearable electronic device. For example, the head-wearable electronic device may be an example of a wearable device 201 and/or an electronic device 101. For example, the operations of the head-wearable electronic device may be executed, performed, or controlled by at least one processor (e.g., the at least one processor 410).

For convenience of description in the disclosure, a perception module for generating or obtaining requested perception data may be referred to as a target perception module.

Referring to FIG. 9, in operation 901, the head-wearable electronic device may identify an event requesting the perception data. For example, the at least one processor may be utilized by the perception module for generating the perception data. For example, the operation 901 of FIG. 9 may correspond to the operation 801 of FIG. 8. For the operation 901 of FIG. 9, descriptions of the operation 801 of FIG. 8 may be referred to.

In operation 903, the head-wearable electronic device may identify that the at least one processor is utilized by one or more of perception modules using a control module (e.g., the control module 720). For example, the head-wearable electronic device may identify that the at least one processor is utilized by the one or more of the perception modules in accordance with an operation state of each of the perception modules. For example, the at least one processor may be included in a system resource (e.g., the system resource 730). For example, each of the perception modules may be available in the head-wearable electronic device. For example, the perception module may be one or more of the head tracking perception module 471, the scene perception module 472, the hand tracking perception module 473, the eye tracking perception module 474, and the face tracking perception module 475 of FIG. 4. For example, the operation 903 of FIG. 9 may correspond to at least a portion of the operation 805 of FIG. 8.

In operation 905, the head-wearable electronic device may identify a scheduling priority level of each of the perception modules, by using the control module. For example, the scheduling priority level may be included, stored, or retained in system resource information (e.g., the system resource information 725). For example, in a case that each perception module (or a task of each perception module) is processed (or executed) by the at least one processor (e.g., a CPU and an NPU), the scheduling priority level may be referred to in an order in which each perception module (or the task of each perception module) is processed by the at least one processor. For example, descriptions of the scheduling priority level of FIG. 7 may be referred to for the scheduling priority level.

In operation 907, the head-wearable electronic device may perform scheduling of the at least one processor, by using the control module, based on the scheduling priority level of each of the perception modules. For example, by performing the scheduling of the at least one processor, the head-wearable electronic device may determine a processing order of the one or more of the perception modules utilizing the at least one processor and/or the target perception module to generate the requested perception data. As a non-limiting example, the target perception module may be included in the one or more of the perception modules utilizing the at least one processor.

In operation 909, the head-wearable electronic device may obtain the perception data based on the scheduling of the at least one processor. For example, the head-wearable electronic device may execute, perform, or process a task (or a calculation) of the target perception module to generate the requested perception data according to a processing order determined according to the scheduling of the at least one processor. For example, the head-wearable electronic device may obtain the requested perception data by executing the task (or the calculation) of the target perception module. For example, the head-wearable electronic device may provide an application module (e.g., the application modules 711 and 712) using the perception data with the perception data. For example, the head-wearable electronic device may provide a function associated with an XR (or a VR, or an AR, or an MR) using the obtained perception data.

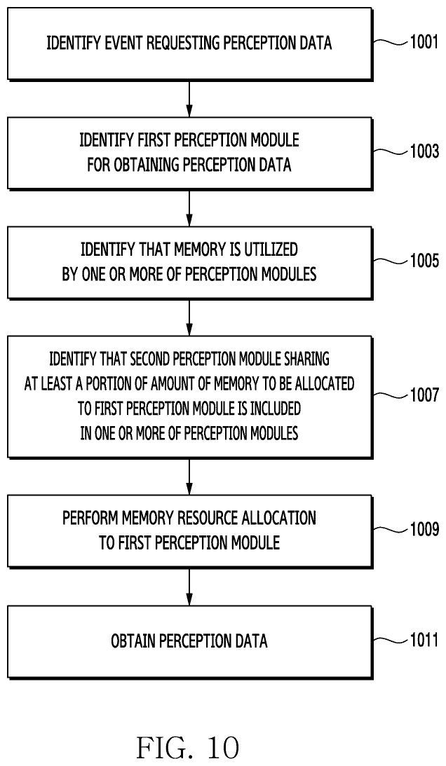

FIG. 10 illustrates an example of operations of a head-wearable electronic device that obtains perception data by performing memory resource allocation according to an embodiment of the disclosure. The operations exemplified in FIG. 10 may be performed in the head-wearable electronic device. For example, the head-wearable electronic device may be an example of a wearable device 201 and/or an electronic device 101. For example, the operations of the head-wearable electronic device may be executed, performed, or controlled by at least one processor (e.g., the at least one processor 410).

Referring to FIG. 10, in operation 1001, the head-wearable electronic device may identify an event requesting the perception data. For example, memory (e.g., the memory 415) may be utilized by a perception module for generating the perception data. For example, the operation 1001 of FIG. 10 may correspond to the operation 801 of FIG. 8. For the operation 1001 of FIG. 10, descriptions of the operation 801 of FIG. 8 may be referred to.

In operation 1003, the head-wearable electronic device may identify a first perception module for obtaining the perception data using a control module (e.g., the control module 720). For example, the first perception module may be one or more of the head tracking perception module 471, the scene perception module 472, the hand tracking perception module 473, the eye tracking perception module 474, and the face tracking perception module 475 of FIG. 4. For example, the head-wearable electronic device may identify the first perception module for obtaining the perception data among perception modules. For example, in a case that the requested perception data is data associated with iris recognition, the head-wearable electronic device may identify the eye tracking perception module 474 as the first perception module. For example, the head-wearable electronic device may determine to allocate an amount of the memory to the first perception module to obtain the perception data.

In operation 1005, the head-wearable electronic device may identify, by using the control module, that the memory is utilized by one or more of the perception modules. For example, the head-wearable electronic device may identify that the memory is utilized by the one or more of the perception modules in accordance with an operation state of each of the perception modules. For example, the memory may be included in a system resource (e.g., the system resource 730). For example, the operation 1005 of FIG. 10 may correspond to at least a portion of the operation 805 of FIG. 8.

In operation 1007, the head-wearable electronic device may identify, by using the control module, that a second perception module sharing at least a portion of the amount of the memory to be allocated to the first perception module is included in the one or more of the perception modules utilizing the memory. For example, the amount of the memory to be allocated to the first perception module may be determined in advance according to pre-allocation. For example, the amount of the memory to be allocated to the second perception module may be determined in advance according to the pre-allocation. For example, the at least a portion of the amount of the memory to be allocated to the first perception module may be shared with the amount of the memory to be allocated to the second perception module. For example, the head-wearable electronic device may be set such that the at least a portion of the amount of the memory to be allocated to the first perception module and the amount of the memory to be allocated to the second perception module are shared.

In operation 1009, the head-wearable electronic device may perform the memory resource allocation to the first perception module by using the control module. For example, the head-wearable electronic device may allocate to the first perception module a predetermined amount of the memory to be allocated to the first perception module. For example, the head-wearable electronic device may perform the memory resource allocation to the first perception module according to a difference between the amount of the memory to be allocated to the first perception module and the amount of the shared memory. For example, the head-wearable electronic device may efficiently utilize the memory resource by performing the memory resource allocation to the first perception module according to the difference between the amount of the memory to be allocated to the first perception module and the amount of the shared memory.

In operation 1011, the head-wearable electronic device may obtain the perception data based on performing the memory resource allocation to the first perception module. For example, the head-wearable electronic device may obtain the requested perception data by utilizing the first perception module. For example, the head-wearable electronic device may provide the perception data to an application module (e.g., the application modules 711 and 712) using the perception data. For example, the head-wearable electronic device may provide a function associated with an XR (or a VR, or an AR, or an MR) using the obtained perception data.

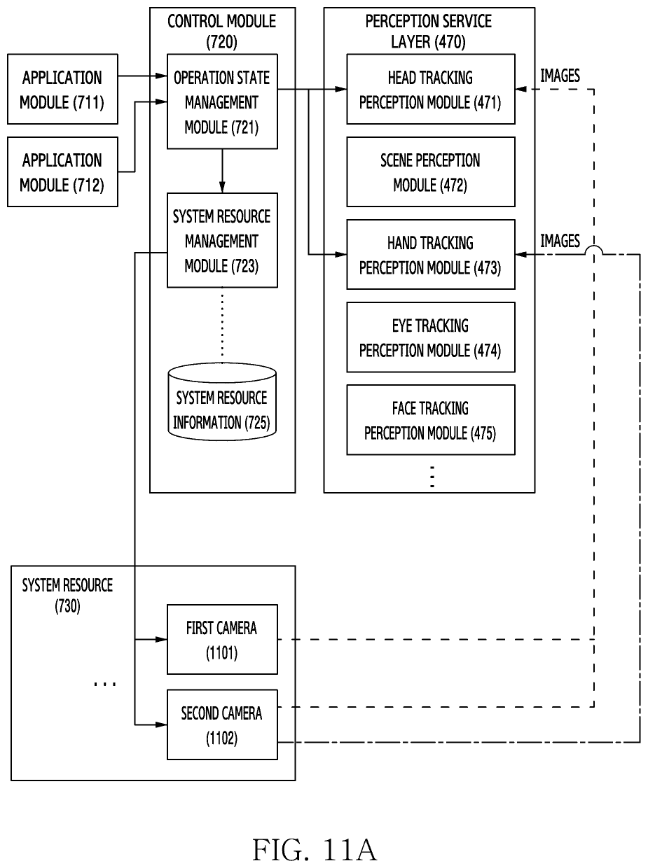

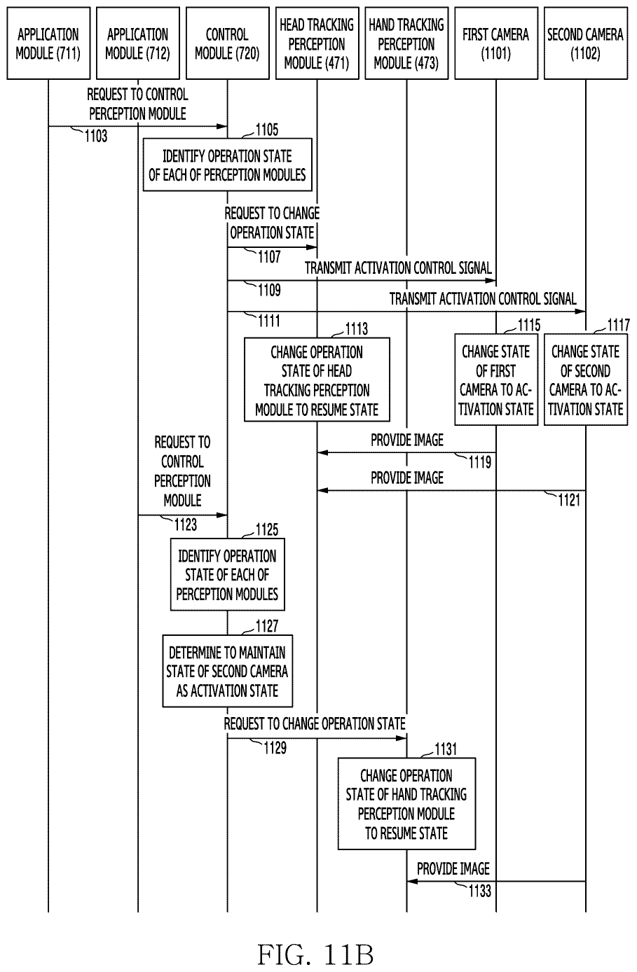

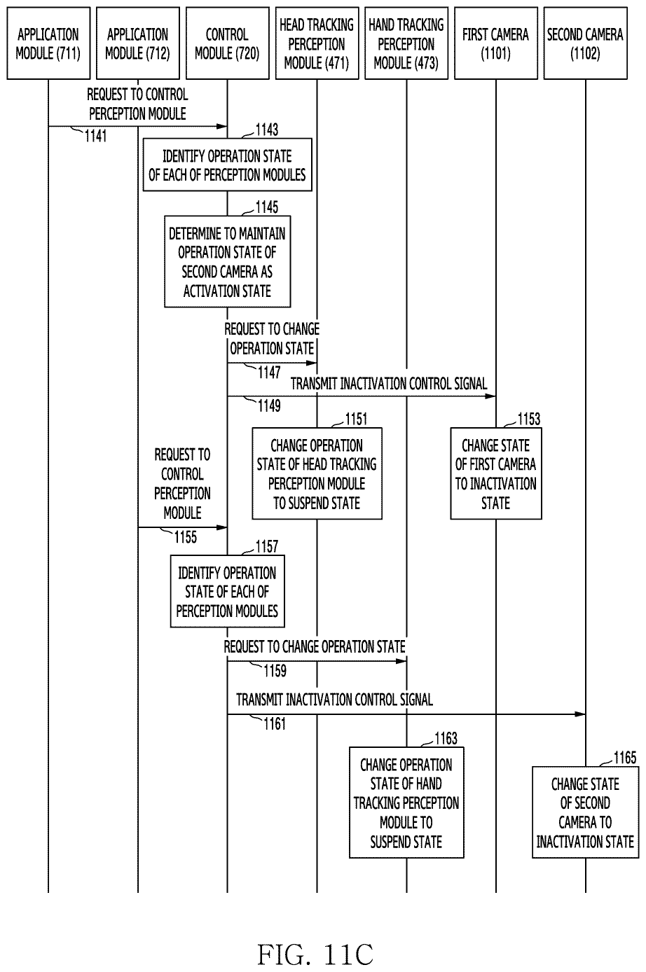

FIGS. 11A, 11B, and 11C illustrate an example in which an operation state of a perception module and a state of one or more cameras are changed according to various embodiments of the disclosure. Operations exemplified in FIGS. 11A, 11B, and/or 11C may be performed in a head-wearable electronic device. For example, the head-wearable electronic device may be an example of a wearable device 201 and/or an electronic device 101. For example, the operations of the head-wearable electronic device may be executed, performed, or controlled by at least one processor (e.g., the at least one processor 410).

Referring to FIG. 11A, components of the head-wearable electronic device are illustrated. The head-wearable electronic device may include application modules 711 and 712, a control module 720, a perception service layer 470, and/or a system resource 730. To reduce repetition of a description, redundant descriptions may be omitted. The descriptions of FIG. 4 and/or the descriptions of FIG. 7 may be referred to for the application modules 711 and 712, the control module 720, the perception service layer 470, and/or the system resource 730.

According to an embodiment, an application module 711 may provide a function by using first perception data (e.g., head tracking data). For example, the head-wearable electronic device may provide a head gesture function using the application module 711. For example, the head gesture function may be referred to as a function of perceiving movement of a head of a user as an input of the head-wearable electronic device. For example, the first perception data may be generated by a head tracking perception module 471.

The application module 711 may provide or transmit a request associated with the first perception data to the control module 720 (e.g., the operation state management module 721). For example, the request associated with the first perception data may be referred to as a request for the application module 711 to obtain the first perception data. For example, the request associated with the first perception data may include changing the operation state of the head tracking perception module 471 that generates the first perception data. As a non-limiting example, the request associated with the first perception data may include requesting allocation of the system resource 730 utilized by the head tracking perception module 471.

The operation state management module 721 in the control module 720 may, in response to receiving the request, identify an operation state of perception modules in the perception service layer 470. For example, the perception modules may include the head tracking perception module 471, a scene perception module 472, a hand tracking perception module 473, an eye tracking perception module 474, and a face tracking perception module 475. For example, the operation state management module 721 may identify the operation state of the head tracking perception module 471.

According to an embodiment, the operation state management module 721 may request the head tracking perception module 471 to change the operation state based on identifying that the operation state of the head tracking perception module 471 is a suspend state (e.g., the suspend state 603). For example, the head tracking perception module 471 may provide or transmit a request signal (or a control signal) for changing the operation state of the head tracking perception module 471 from the suspend state to a resume state. For example, the head tracking perception module 471 may control the operation state of the head tracking perception module 471 to change from the suspend state to the resume state.

According to an embodiment, the operation state management module 721 may not request the head tracking perception module 471 to change the operation state based on identifying that the operation state of the head tracking perception module 471 is the resume state (e.g., the resume state 605). For example, the operation state management module 721 may refrain from or bypass requesting the head tracking perception module 471 to change the operation state. For example, the head tracking perception module 471 may not provide (or transmit) the request signal (or the control signal) for changing the operation state of the head tracking perception module 471 from the suspend state to the resume state. For example, the head tracking perception module 471 may not control the operation state of the head tracking perception module 471 to change from the suspend state to the resume state. For example, the operation state of the head tracking perception module 471 may be maintained as the resume state.

According to an embodiment, the operation state management module 721 may request a system resource management module 723 to control the allocation of the system resource 730. For example, the operation state management module 721 may provide or transmit the request signal (or the control signal) for controlling the allocation of the system resource 730 to the system resource management module 723. For example, the operation state management module 721 may control the system resource management module 723 to control the allocation of the system resource 730.

The system resource management module 723 may perform allocation of the system resource 730 for generating the first perception data. For example, the system resource management module 723 may allocate at least a portion of the system resource 730 utilized by the head tracking perception module 471 to the head tracking perception module 471. For example, the head tracking perception module 471 may generate the first perception data according to images obtained via a first camera 1101 and/or images obtained via a second camera 1102. For example, the first camera 1101 and/or the second camera 1102 may be included in the one or more cameras 430 of FIG. 4.

The system resource management module 723 may allocate the first camera 1101 and/or the second camera 1102 to the head tracking perception module 471. The system resource management module 723 may identify whether the camera (e.g., the first camera 1101 and the second camera 1102) is being utilized by other perception module(s) according to the operation state of the perception modules. For example, the system resource management module 723 may identify whether the state of the camera (e.g., the first camera 1101 and the second camera 1102) is an activation state or an inactivation state, according to the operation state of the perception modules. For example, the head-wearable electronic device may obtain the images by utilizing the camera in the activation state, as the other perception module(s) utilize the camera. As a non-limiting example, the head-wearable electronic device may change the state of the camera from the inactivation state to the activation state as the other perception module(s) do not utilize the camera. For example, the head-wearable electronic device may start utilizing the camera changed as the activation state. For example, the head-wearable electronic device may obtain the images utilizing the camera.

According to an embodiment, the images obtained via the first camera 1101 may be provided to the head tracking perception module 471. For example, the images obtained via the second camera 1102 may be provided to the head tracking perception module 471. The head tracking perception module 471 may generate or obtain the first perception data by using the provided images. The head tracking perception module 471 may provide or transmit the first perception data to the application module 711.

According to an embodiment, an application module 712 may provide a function by using second perception data (e.g., hand tracking data). For example, the head-wearable electronic device may provide a hand gesture function using the application module 712. For example, the hand gesture function may be referred to as a function of perceiving movement of a hand of the user as an input of the head-wearable electronic device. For example, the second perception data may be generated by the hand tracking perception module 473.

The application module 712 may provide or transmit a request associated with the second perception data to the control module 720 (e.g., the operation state management module 721). For example, the request associated with the second perception data may be referred to as a request for the application module 712 to obtain the second perception data. For example, the request associated with the second perception data may include changing the operation state of the hand tracking perception module 473 that generates the second perception data. As a non-limiting example, the request associated with the second perception data may include requesting the allocation of the system resource 730 utilized by the hand tracking perception module 473.

The operation state management module 721 in the control module 720 may identify the operation state of the perception modules in the perception service layer 470 in response to receiving the request. For example, the operation state management module 721 may identify the operation state of the hand tracking perception module 473.

According to an embodiment, the operation state management module 721 may request the hand tracking perception module 473 to change the operation state based on identifying that the operation state of the hand tracking perception module 473 is the suspend state. For example, the hand tracking perception module 473 may provide or transmit the request signal (or the control signal) for changing the operation state of the hand tracking perception module 473 from the suspend state to the resume state. For example, the hand tracking perception module 473 may control the operation state of the hand tracking perception module 473 to change from the suspend state to the resume state.

According to an embodiment, the operation state management module 721 may not request the hand tracking perception module 473 to change the operation state based on identifying that the operation state of the hand tracking perception module 473 is the resume state. For example, the operation state management module 721 may refrain from or bypass requesting the hand tracking perception module 473 to change the operation state. For example, the hand tracking perception module 473 may not provide (or transmit) the request signal (or the control signal) for changing the operation state of the hand tracking perception module 473 from the suspend state to the resume state. For example, the hand tracking perception module 473 may not control the operation state of the hand tracking perception module 473 to change from the suspend state to the resume state. For example, the operation state of the hand tracking perception module 473 may be maintained as the resume state.

According to an embodiment, the operation state management module 721 may request the system resource management module 723 to control the allocation of the system resource 730. For example, the operation state management module 721 may provide or transmit the request signal (or the control signal) for controlling the allocation of the system resource 730 to the system resource management module 723. For example, the operation state management module 721 may control the system resource management module 723 to control the allocation of the system resource 730.

The system resource management module 723 may perform allocation of the system resource 730 for generating the second perception data. For example, the system resource management module 723 may allocate the at least a portion of the system resource 730 utilized by the hand tracking perception module 473 to the hand tracking perception module 473. For example, the hand tracking perception module 473 may generate the second perception data according to the images obtained via the second camera 1102.

The system resource management module 723 may allocate the second camera 1102 to the hand tracking perception module 473. The system resource management module 723 may identify whether the second camera 1102 is being utilized by the other perception module(s) according to the operation state of the perception modules.

According to an embodiment, the system resource management module 723 may identify whether a state of the second camera 1102 is the activation state or the inactivation state according to the operation state of the perception modules. For example, the system resource management module 723 may identify that the state of the second camera 1102 is the activation state according to the head tracking perception module 471 in the resume state. For example, as the head tracking perception module 471 utilizes the second camera 1102, the head-wearable electronic device may obtain the images utilizing the second camera 1102 in the activation state. For example, the images obtained via the second camera 1102 may be provided to the hand tracking perception module 473. The hand tracking perception module 473 may generate or obtain the second perception data using the provided images. The hand tracking perception module 473 may provide or transmit the second perception data to the application module 712.

Referring to FIG. 11B, in operation 1103, the application module 711 may request the control module 720 to control the perception module. For example, the control of the perception module in operation 1103 may be referred to as the application module 711 causing the perception module to change the operation state to obtain the perception data (e.g., the first perception data of FIG. 11A).

In operation 1105, the control module 720 may identify the operation state of each of the perception modules. For example, the control module 720 may identify the operation state of the head tracking perception module 471 and/or the operation state of the hand tracking perception module 473.

In operation 1107, the control module 720 may request the head tracking perception module 471 to change the operation state according to the operation state of each of the perception modules. For example, the control module 720 may request the head tracking perception module 471 to change the operation state according to the operation state of the head tracking perception module 471. For example, the control module 720 may request that the operation state of the head tracking perception module 471 be changed to the resume state in response to identifying that the operation state of the head tracking perception module 471 is the operation state (e.g., the suspend state 603) different from the resume state (e.g., the resume state 605). For example, based on the operation 1107, operation 1113 may be performed.

In operation 1109, the control module 720 may transmit or provide an activation control signal to the first camera 1101. For example, the activation control signal may be referred to as a signal for changing the state of the first camera 1101 from the inactivation state to the activation state. For example, based on the operation 1109, operation 1115 may be performed.

In operation 1111, the control module 720 may transmit or provide an activation control signal to the second camera 1102. For example, based on the operation 1111, operation 1117 may be performed.

In operation 1113, the head tracking perception module 471 may change the operation state of the head tracking perception module 471 to the resume state (e.g., the resume state 605). For example, the head tracking perception module 471 may change the operation state of the head tracking perception module 471 from the suspend state (e.g., the suspend state 603) to the resume state.

In operation 1115, the first camera 1101 may change the state of the first camera 1101 to the activation state. For example, the first camera 1101 may change the state of the first camera 1101 from the inactivation state to the activation state.

In operation 1117, the second camera 1102 may change the state of the second camera 1102 to the activation state. For example, the second camera 1102 may change the state of the second camera 1102 from the inactivation state to the activation state.

In operation 1119, the first camera 1101 may provide an image to the head tracking perception module 471. For example, the image may be obtained via the first camera 1101. For example, the head tracking perception module 471 may obtain or generate the perception data using the image obtained via the first camera 1101.

In operation 1121, the second camera 1102 may provide an image to the head tracking perception module 471. For example, the image may be obtained via the second camera 1102. For example, the head tracking perception module 471 may obtain or generate the perception data using the image obtained via the second camera 1102.

In operation 1123, the application module 712 may request the control module 720 to control the perception module. For example, the control of the perception module in operation 1123 may be referred to as the application module 712 causing the perception module to change the operation state to obtain the perception data (e.g., the second perception data of FIG. 11A).

In operation 1125, the control module 720 may identify the operation state of each of the perception modules. For example, the control module 720 may identify the operation state of the head tracking perception module 471 and/or the operation state of the hand tracking perception module 473.

In operation 1127, the control module 720 may determine to maintain the state of the second camera 1102 as the activation state based on the operation state of the head tracking perception module 471 in the resume state. For example, the control module 720 may identify that the state of the second camera 1102 is the activation state according to the operation state of the head tracking perception module 471. For example, the control module 720 may maintain the state of the second camera 1102 as the activation state. For example, the control module 720 may not transmit the activation control signal to the second camera 1102. For example, the control module 720 may refrain from or bypass transmitting the activation control signal to the second camera 1102.

In operation 1129, the control module 720 may request the hand tracking perception module 473 to change the operation state according to the operation state of each of the perception modules. For example, the control module 720 may request the hand tracking perception module 473 to change the operation state according to the operation state of the hand tracking perception module 473. For example, the control module 720 may request that the operation state of the hand tracking perception module 473 be changed to the resume state in response to identifying that the operation state of the hand tracking perception module 473 is the operation state (e.g., the suspend state 603) different from the resume state (e.g., the resume state 605).

In operation 1131, the hand tracking perception module 473 may change the operation state of the hand tracking perception module 473 to the resume state. For example, the hand tracking perception module 473 may change the operation state of the hand tracking perception module 473 from the suspend state to the resume state.

In operation 1133, the second camera 1102 may provide an image to the hand tracking perception module 473. For example, the image may be obtained via the second camera 1102. For example, the hand tracking perception module 473 may obtain or generate the perception data using the image obtained via the second camera 1102.

Referring to FIG. 11C, in operation 1141, the application module 711 may request the control module 720 to control the perception module. For example, the control of the perception module in operation 1141 may be referred to as causing the perception module to change the operation state as the application module 711 completes obtaining the perception data. As a non-limiting example, the operations exemplified in FIG. 11C may be performed after the operations exemplified in FIG. 11B.

In operation 1141, the application module 711 may request the control module 720 to control the perception module. For example, the control of the perception module in operation 1141 may be referred to as the application module 711 causing the perception module to change the operation state as the obtaining of the perception data (e.g., the first perception data of FIG. 11A) is completed.

In operation 1143, the control module 720 may identify the operation state of each of the perception modules. For example, the control module 720 may identify the operation state of the head tracking perception module 471 and/or the operation state of the hand tracking perception module 473.

In operation 1145, the control module 720 may determine to maintain the state of the second camera 1102 as the activation state based on the operation state of the hand tracking perception module 473 in the resume state. For example, the control module 720 may identify that the state of the second camera 1102 is the activation state according to the operation state of the hand tracking perception module 473. For example, the control module 720 may determine to maintain the state of the second camera 1102 as the activation state based on identifying that the hand tracking perception module 473 utilizes the second camera 1102. For example, the control module 720 may maintain the state of the second camera 1102 as the activation state. For example, the control module 720 may not transmit an inactivation control signal to the second camera 1102. For example, the control module 720 may refrain from or bypass transmitting the inactivation control signal to the second camera 1102.

In operation 1147, the control module 720 may request the head tracking perception module 471 to change the operation state according to the operation state of each of the perception modules. For example, the control module 720 may request that the operation state of the head tracking perception module 471 be changed to the suspend state in response to identifying that the operation state of the head tracking perception module 471 is the operation state (e.g., the resume state 605) different from the suspend state (e.g., the suspend state 603). For example, based on the operation 1147, operation 1151 may be performed.

In operation 1149, the control module 720 may transmit or provide an inactivation control signal to the first camera 1101. For example, the inactivation control signal may be referred to as a signal for changing the state of the first camera 1101 from the activation state to the inactivation state. For example, based on the operation 1149, operation 1153 may be performed.

In operation 1151, the head tracking perception module 471 may change the operation state of the head tracking perception module 471 to the suspend state. For example, the head tracking perception module 471 may change the operation state of the head tracking perception module 471 from the resume state to the suspend state.

In operation 1153, the first camera 1101 may change the state of the first camera 1101 to the inactivation state. For example, the first camera 1101 may change the state of the first camera 1101 from the activation state to the inactivation state.

In operation 1155, the application module 712 may request the control module 720 to control the perception module. For example, the control of the perception module in operation 1155 may be referred to as the application module 712 causing the perception module to change the operation state as the obtaining of the perception data (e.g., the second perception data of FIG. 11A) is completed.

In operation 1157, the control module 720 may identify the operation state of each of the perception modules. For example, the control module 720 may identify the operation state of the head tracking perception module 471 and/or the operation state of the hand tracking perception module 473.

In operation 1159, the control module 720 may request the hand tracking perception module 473 to change the operation state according to the operation state of each of the perception modules. For example, the control module 720 may request that the operation state of the hand tracking perception module 473 be changed to the suspend state in response to identifying that the operation state of the hand tracking perception module 473 is the operation state (e.g., the resume state 605) different from the suspend state (e.g., the suspend state 603). For example, based on the operation 1159, operation 1163 may be performed.

In operation 1161, the control module 720 may transmit or provide an inactivation control signal to the second camera 1102. For example, based on the operation 1161, operation 1165 may be performed.

In operation 1163, the hand tracking perception module 473 may change the operation state of the hand tracking perception module 473 to the suspend state. For example, the hand tracking perception module 473 may change the operation state of the hand tracking perception module 473 from the resume state to the suspend state.

In operation 1165, the second camera 1102 may change the state of the second camera 1102 to the inactivation state. For example, the second camera 1102 may change the state of the second camera 1102 from the activation state to the inactivation state.

For convenience of description, the first camera 1101 and the second camera 1102 are exemplified in FIGS. 11A, 11B, and 11C, but it is not intended to limit an embodiment of the disclosure. The descriptions of the first camera 1101 and the second camera 1102 illustrated in FIGS. 11A, 11B, and 11C may be changed or substituted for another system resource 730, as easily understood by those having ordinary knowledge in the art to which the disclosure belongs. For example, each of the first camera 1101 and the second camera 1102 may be changed or substituted for a sensor included in the one or more sensors 420 of FIG. 4. It may also be understood that all such changes (or substitutions) are included in embodiments of the disclosure.

In an embodiment according to the disclosure, the control module (e.g., the control module 720) in the head-wearable electronic device (e.g., the wearable device 201) may control a change in the operation state of the perception module according to the operation state of each of the perception modules. In addition, the control module may control the allocation of the system resource (e.g., the system resource 730) utilized by each of the perception modules according to the operation state of each of the perception modules. For example, as the control module performs processing for each perception module according to the operation state of the other perception modules, an amount of a signal (or a request) transmitted between the components in the head-wearable electronic device may be decreased. For example, the number of times of overwriting of a signal for the same service may be decreased. For example, an amount of a calculation performed by the at least one processor (e.g., the at least one processor 410) of the head-wearable electronic device may be decreased. For example, an amount of a calculation in a case that the processing for each perception module is processed according to the operation state of the other perception module may be smaller than an amount of a calculation in a case that the processing for each perception module is processed independently of the operation state of the other perception module. For example, as the amount of the calculation performed by the at least one processor is decreased, a quality of a function (e.g., a function of displaying an image representing a virtual space and a pass-through function) provided by the head-wearable electronic device may be improved.

The effects that may be obtained from the disclosure are not limited to those described above, and any other effects not mentioned herein will be clearly understood by those having ordinary knowledge in the art to which the disclosure belongs, from the following description.

The technical problems to be achieved in the disclosure are not limited to those described above, and other technical problems not mentioned herein will be clearly understood by those having ordinary knowledge in the art to which the disclosure belongs.

A head-wearable electronic device as described above may include memory including one or more storage media storing instructions. The head-wearable electronic device may include at least one processor including processing circuitry. The instructions, when executed by the at least one processor individually or collectively, may cause the head-wearable electronic device to identify an event requesting perception data generated by utilizing a system resource. The instructions, when executed by the at least one processor individually or collectively, based on the event, may cause the head-wearable electronic device to identify an operation state of each of perception modules available in the head-wearable electronic device, by using a control module different from the perception modules. The instructions, when executed by the at least one processor individually or collectively, based on identifying, in accordance with the identified operation state of each of the perception modules, that the system resource for generating the requested perception data is being utilized by one or more of the perception modules, may cause the head-wearable electronic device to obtain the requested perception data through the system resource utilized by the one or more of the perception modules. The instructions, when executed by the at least one processor individually or collectively, based on identifying, in accordance with the identified operation state of each of the perception modules, that the system resource for generating the requested perception data is being unutilized by the perception modules, may cause the head-wearable electronic device to start, by using the control module, utilizing the system resource for obtaining the requested perception data.

According to an embodiment, the head-wearable electronic device may include a camera. The system resource for generating the requested perception data may include the camera. The instructions, when executed by the at least one processor individually or collectively, may cause the head-wearable electronic device to, based on identifying, in accordance with the identified operation state of each of the perception modules, that the camera for generating the requested perception data is being utilized by the one or more of the perception modules, maintain, by using the control module, a state of the camera as an activation state. The instructions, when executed by the at least one processor individually or collectively, may cause the head-wearable electronic device to obtain the requested perception data, using an image obtained via the camera being maintained in the activation state.

According to an embodiment, the camera may be utilized by a perception module for obtaining the requested perception data among the perception modules. The instructions, when executed by the at least one processor individually or collectively, may cause the head-wearable electronic device to, after obtaining the requested perception data, identify, by using the control module, that the perception module for obtaining the requested perception data has ceased utilizing the camera. The instructions, when executed by the at least one processor individually or collectively, may cause the head-wearable electronic device to, based on identifying that the perception module for obtaining the requested perception data has ceased utilizing the camera, identify again, by using the control module, the operation state of each of the perception modules. The instructions, when executed by the at least one processor individually or collectively, may cause the head-wearable electronic device to, based on identifying, in accordance with the re-identified operation state of each of the perception modules, that the camera is being utilized by at least one of the perception modules, maintain, by using the control module, the state of the camera as the activation state. The instructions, when executed by the at least one processor individually or collectively, may cause the head-wearable electronic device to, based on identifying, in accordance with the re-identified operation state of each of the perception modules, that the camera is not being utilized by the perception modules, change, by using the control module, the state of the camera from the activation state to an inactivation state.

According to an embodiment, the instructions, when executed by the at least one processor individually or collectively, may cause the head-wearable electronic device to, based on identifying, in accordance with the re-identified operation state of each of the perception modules, that the camera is being utilized by the at least one of the perception modules, identify, by using the control module, a camera setting corresponding to the at least one of the perception modules. The instructions, when executed by the at least one processor individually or collectively, may cause the head-wearable electronic device to, by applying the camera setting to the camera, maintain, by using the control module, the state of the camera as the activation state.

According to an embodiment, the instructions, when executed by the at least one processor individually or collectively, may cause the head-wearable electronic device to, based on identifying, in accordance with the identified operation state of each of the perception modules, that the camera is not being utilized by the perception modules, change, by using the control module, the state of the camera from an inactivation state to the activation state. The instructions, when executed by the at least one processor individually or collectively, may cause the head-wearable electronic device to obtain the requested perception data, by using an image obtained via the camera changed as the activation state.

According to an embodiment, the camera may be utilized by a perception module for obtaining the requested perception data among the perception modules. The instructions, when executed by the at least one processor individually or collectively, may cause the head-wearable electronic device to, after obtaining the requested perception data, identify, by using the control module, that the perception module for obtaining the requested perception data has ceased utilizing the camera. The instructions, when executed by the at least one processor individually or collectively, may cause the head-wearable electronic device to, based on identifying that the perception module for obtaining the requested perception data has ceased utilizing the camera, identify again, by using the control module, the operation state of each of the perception modules. The instructions, when executed by the at least one processor individually or collectively, may cause the head-wearable electronic device to, based on identifying, in accordance with the re-identified operation state of each of the perception modules, that the camera is being utilized by at least one of the perception modules, maintain, by using the control module, the state of the camera as the activation state. The instructions, when executed by the at least one processor individually or collectively, may cause the head-wearable electronic device to, based on identifying, in accordance with the re-identified operation state of each of the perception modules, that the camera is not being utilized by the perception modules, change, by using the control module, the state of the camera from the activation state to the inactivation state.

According to an embodiment, the instructions, when executed by the at least one processor individually or collectively, may cause the head-wearable electronic device to, based on identifying, in accordance with the re-identified operation state of each of the perception modules, that the camera is being utilized by the at least one of the perception modules, identify, by using the control module, a camera setting corresponding to the at least one of the perception modules. The instructions, when executed by the at least one processor individually or collectively, may cause the head-wearable electronic device to, by applying the camera setting to the camera, maintain, by using the control module, the state of the camera as the activation state.

According to an embodiment, the system resource for generating the requested perception data may include the at least one processor. The instructions, when executed by the at least one processor individually or collectively, may cause the head-wearable electronic device to, based on identifying, in accordance with the identified operation state of each of the perception modules, that the at least one processor for generating the requested perception data is being utilized by the one or more of the perception modules, identify, by using the control module, a scheduling priority level of a perception module for obtaining the requested perception data among the perception modules. The instructions, when executed by the at least one processor individually or collectively, may cause the head-wearable electronic device to, based on the scheduling priority level of the perception module for obtaining the requested perception data, perform, by using the control module, scheduling of the at least one processor. The instructions, when executed by the at least one processor individually or collectively, may cause the head-wearable electronic device to, based on the performed scheduling of the at least one processor, obtain the requested perception data.

According to an embodiment, the system resource for generating the requested perception data may include the memory. The instructions, when executed by the at least one processor individually or collectively, may cause the head-wearable electronic device to, based on identifying, in accordance with the identified operation state of each of the perception modules, that the memory for generating the requested perception data is being utilized by the one or more of the perception modules, identify, by using the control module, a perception module for obtaining the requested perception data among the perception modules. The instructions, when executed by the at least one processor individually or collectively, may cause the head-wearable electronic device to identify, by using the control module, that another perception module shared at least a portion of amount of the memory to be allocated to the perception module is included in the one or more of the perception modules utilizing the memory. The instructions, when executed by the at least one processor individually or collectively, may cause the head-wearable electronic device to, based on performing, by using the control module, memory resource allocation to the perception module in accordance with a difference between the amount of the memory to be allocated to the perception module and the at least a portion of the amount of the memory to be allocated to the perception module, obtain the requested perception data.

According to an embodiment, the instructions, when executed by the at least one processor individually or collectively, may cause the head-wearable electronic device to, based on the event, identify, by using the control module, an operation state of a perception module for obtaining the requested perception data among the perception modules. The instructions, when executed by the at least one processor individually or collectively, may cause the head-wearable electronic device to, based on identifying the operation state of the perception module being a resume state, maintain, by using the control module, the operation state of the perception module as the resume state. The instructions, when executed by the at least one processor individually or collectively, may cause the head-wearable electronic device to, based on identifying the operation state of the perception module being a suspend state, change, by using the control module, the operation state of the perception module from the suspend state to the resume state.

According to an embodiment, the instructions, when executed by the at least one processor individually or collectively, may cause the head-wearable electronic device to, in response to changing the operation state of the perception module from the suspend state to the resume state, change, by using the control module, an operation state of another perception module associated with the perception module among the perception modules from the suspend state to the resume state.

According to an embodiment, the instructions, when executed by the at least one processor individually or collectively, may cause the head-wearable electronic device to, after obtaining the requested perception data, identify whether a perception module for obtaining the requested perception data among the perception modules is used to obtain other perception data. The instructions, when executed by the at least one processor individually or collectively, may cause the head-wearable electronic device to, based on identifying that the perception module is used to obtain the other perception data, maintain, by using the control module, the operation state of the perception module as a resume state. The instructions, when executed by the at least one processor individually or collectively, may cause the head-wearable electronic device to, based on identifying that the perception module is not used to obtain the other perception data, change, by using the control module, the operation state of the perception module from the resume state to a suspend state.

According to an embodiment, the head-wearable electronic device may include a sensor. The system resource for generating the requested perception data may include the sensor. The instructions, when executed by the at least one processor individually or collectively, may cause the head-wearable electronic device to, based on identifying, in accordance with the identified operation state of each of the perception modules, that the sensor for generating the requested perception data is being utilized by the one or more of the perception modules, maintain, by using the control module, a state of the sensor as an activation state. The instructions, when executed by the at least one processor individually or collectively, may cause the head-wearable electronic device to obtain the requested perception data, using sensor data obtained via the sensor being maintained in the activation state.

According to an embodiment, the sensor may be utilized by a perception module for obtaining the requested perception data among the perception modules. The instructions, when executed by the at least one processor individually or collectively, may cause the head-wearable electronic device to, after obtaining the requested perception data, identify, by using the control module, that the perception module for obtaining the requested perception data has ceased utilizing the camera. The instructions, when executed by the at least one processor individually or collectively, may cause the head-wearable electronic device to, based on identifying that the perception module for obtaining the requested perception data has ceased utilizing the sensor, identify again, by using the control module, the operation state of each of the perception modules. The instructions, when executed by the at least one processor individually or collectively, may cause the head-wearable electronic device to, based on identifying, in accordance with the re-identified operation state of each of the perception modules, that the sensor is being utilized by at least one of the perception modules, maintain, by using the control module, the state of the sensor as the activation state. The instructions, when executed by the at least one processor individually or collectively, may cause the head-wearable electronic device to, based on identifying, in accordance with the re-identified operation state of each of the perception modules, that the sensor is not being utilized by the perception modules, change, by using the control module, the state of the sensor from the activation state to an inactivation state.

According to an embodiment, the instructions, when executed by the at least one processor individually or collectively, may cause the head-wearable electronic device to, based on identifying, in accordance with the re-identified operation state of each of the perception modules, that the sensor is being utilized by the at least one of the perception modules, identify, by using the control module, a sensor setting corresponding to the at least one of the perception modules. The instructions, when executed by the at least one processor individually or collectively, may cause the head-wearable electronic device to, by applying the sensor setting to the sensor, maintain, by using the control module, the state of the sensor as the activation state.

According to an embodiment, the instructions, when executed by the at least one processor individually or collectively, may cause the head-wearable electronic device to, based on identifying, in accordance with the identified operation state of each of the perception modules, that the sensor is not being utilized by the perception modules, change, by using the control module, the state of the sensor from an inactivation state to the activation state. The instructions, when executed by the at least one processor individually or collectively, may cause the head-wearable electronic device to obtain the requested perception data, by using sensor data obtained via the sensor changed as the activation state.

According to an embodiment, the sensor may be utilized by a perception module for obtaining the requested perception data among the perception modules. The instructions, when executed by the at least one processor individually or collectively, may cause the head-wearable electronic device to, after obtaining the requested perception data, identify, by using the control module, that the perception module for obtaining the requested perception data has ceased utilizing the camera. The instructions, when executed by the at least one processor individually or collectively, may cause the head-wearable electronic device to, based on identifying that the perception module for obtaining the requested perception data has ceased utilizing the sensor, identify again, by using the control module, the operation state of each of the perception modules. The instructions, when executed by the at least one processor individually or collectively, may cause the head-wearable electronic device to, based on identifying, in accordance with the re-identified operation state of each of the perception modules, that the sensor is being utilized by at least one of the perception modules, maintain, by using the control module, the state of the sensor as the activation state. The instructions, when executed by the at least one processor individually or collectively, may cause the head-wearable electronic device to, based on identifying, in accordance with the re-identified operation state of each of the perception modules, that the sensor is not being utilized by the perception modules, change, by using the control module, the state of the sensor from the activation state to the inactivation state.

According to an embodiment, the instructions, when executed by the at least one processor individually or collectively, may cause the head-wearable electronic device to, based on identifying, in accordance with the re-identified operation state of each of the perception modules, that the sensor is being utilized by the at least one of the perception modules, identify, by using the control module, a sensor setting corresponding to the at least one of the perception modules. The instructions, when executed by the at least one processor individually or collectively, may cause the head-wearable electronic device to, by applying the sensor setting to the sensor, maintain, by using the control module, the state of the sensor as the activation state.

According to an embodiment, the perception modules may include at least one of circuitry or a sensor.

According to an embodiment, the control module may include circuitry.

According to an embodiment, the perception modules may include a hand tracking perception module.

According to an embodiment, the perception modules may include a head tracking perception module.

A method performed by a head-wearable electronic device as described above may include identifying, by at least one processor of the head-wearable device, an event requesting perception data generated by utilizing a system resource. The method may include, based on the event, identifying, by the at least one processor, an operation state of each of perception modules available in the head-wearable electronic device, by using a control module different from the perception modules. The method may include, based on identifying, in accordance with the identified operation state of each of the perception modules, that the system resource for generating the requested perception data is being utilized by one or more of the perception modules, obtaining the requested perception data through the system resource utilized by the one or more of the perception modules. The method may include, based on identifying, in accordance with the identified operation state of each of the perception modules, that the system resource for generating the requested perception data is being unutilized by the perception modules, starting, by using the control module, utilizing the system resource for obtaining the requested perception data.

According to an embodiment, the head-wearable electronic device may include a camera. The system resource for generating the requested perception data may include the camera. The method may include, based on identifying, in accordance with the identified operation state of each of the perception modules, that the camera for generating the requested perception data is being utilized by the one or more of the perception modules, maintaining, by using the control module, a state of the camera as an activation state. The method may include obtaining the requested perception data, using an image obtained via the camera being maintained in the activation state.

According to an embodiment, the camera may be utilized by a perception module for obtaining the requested perception data among the perception modules. The method may include, after obtaining the requested perception data, identifying, by using the control module, that the perception module for obtaining the requested perception data has ceased utilizing the camera. The method may include, based on identifying that the perception module for obtaining the requested perception data has ceased utilizing the camera, identifying again, by using the control module, the operation state of each of the perception modules. The method may include, based on identifying, in accordance with the re-identified operation state of each of the perception modules, that the camera is being utilized by at least one of the perception modules, maintaining, by using the control module, the state of the camera as the activation state. The method may include, based on identifying, in accordance with the re-identified operation state of each of the perception modules, that the camera is not being utilized by the perception modules, changing, by using the control module, the state of the camera from the activation state to an inactivation state.

According to an embodiment, the method may include, based on identifying, in accordance with the re-identified operation state of each of the perception modules, that the camera is being utilized by the at least one of the perception modules, identifying, by using the control module, a camera setting corresponding to the at least one of the perception modules. The method may include, by applying the camera setting to the camera, maintaining, by using the control module, the state of the camera as the activation state.

According to an embodiment, the method may include, based on identifying, in accordance with the identified operation state of each of the perception modules, that the camera is not being utilized by the perception modules, changing, by using the control module, the state of the camera from an inactivation state to the activation state. The method may include obtaining the requested perception data, by using an image obtained via the camera changed as the activation state.

According to an embodiment, the camera may be utilized by a perception module for obtaining the requested perception data among the perception modules. The method may include, after obtaining the requested perception data, identifying, by using the control module, that the perception module for obtaining the requested perception data has ceased utilizing the camera. The method may include, based on identifying that the perception module for obtaining the requested perception data has ceased utilizing the camera, identifying again, by using the control module, the operation state of each of the perception modules. The method may include, based on identifying, in accordance with the re-identified operation state of each of the perception modules, that the camera is being utilized by at least one of the perception modules, maintaining, by using the control module, the state of the camera as the activation state. The method may include, based on identifying, in accordance with the re-identified operation state of each of the perception modules, that the camera is not being utilized by the perception modules, changing, by using the control module, the state of the camera from the activation state to the inactivation state.

According to an embodiment, the method may include, based on identifying, in accordance with the re-identified operation state of each of the perception modules, that the camera is being utilized by the at least one of the perception modules, identifying, by using the control module, a camera setting corresponding to the at least one of the perception modules. The method may include, by applying the camera setting to the camera, maintaining, by using the control module, the state of the camera as the activation state.

According to an embodiment, the system resource for generating the requested perception data may include the at least one processor. The method may include, based on identifying, in accordance with the identified operation state of each of the perception modules, that the at least one processor for generating the requested perception data is being utilized by the one or more of the perception modules, identifying, by using the control module, a scheduling priority level of a perception module for obtaining the requested perception data among the perception modules. The method may include, based on the scheduling priority level of the perception module for obtaining the requested perception data, performing, by using the control module, scheduling of the at least one processor. The method may include, based on the performed scheduling of the at least one processor, obtaining the requested perception data.

According to an embodiment, the system resource for generating the requested perception data may include the memory. The method may include, based on identifying, in accordance with the identified operation state of each of the perception modules, that the memory for generating the requested perception data is being utilized by the one or more of the perception modules, identifying, by using the control module, a perception module for obtaining the requested perception data among the perception modules. The method may include identifying, by using the control module, that another perception module shared at least a portion of amount of the memory to be allocated to the perception module is included in the one or more of the perception modules utilizing the memory. The method may include, based on performing, by using the control module, memory resource allocation to the perception module in accordance with a difference between the amount of the memory to be allocated to the perception module and the at least a portion of the amount of the memory to be allocated to the perception module, obtaining the requested perception data.

According to an embodiment, the method may include, based on the event, identifying, by using the control module, an operation state of a perception module for obtaining the requested perception data among the perception modules. The method may include, based on identifying the operation state of the perception module being a resume state, maintaining, by using the control module, the operation state of the perception module as the resume state. The method may include, based on identifying the operation state of the perception module being a suspend state, changing, by using the control module, the operation state of the perception module from the suspend state to the resume state.

According to an embodiment, the method may include, in response to changing the operation state of the perception module from the suspend state to the resume state, changing, by using the control module, an operation state of another perception module associated with the perception module among the perception modules from the suspend state to the resume state.

According to an embodiment, the method may include, after obtaining the requested perception data, identifying whether a perception module for obtaining the requested perception data among the perception modules is used to obtain other perception data. The method may include, based on identifying that the perception module is used to obtain the other perception data, maintaining, by using the control module, the operation state of the perception module as a resume state. The method may include, based on identifying that the perception module is not used to obtain the other perception data, changing, by using the control module, the operation state of the perception module from the resume state to a suspend state.

According to an embodiment, the head-wearable electronic device may include a sensor. The system resource for generating the requested perception data may include the sensor. The method may include, based on identifying, in accordance with the identified operation state of each of the perception modules, that the sensor for generating the requested perception data is being utilized by the one or more of the perception modules, maintaining, by using the control module, a state of the sensor as an activation state. The method may include obtaining the requested perception data, using sensor data obtained via the sensor being maintained in the activation state.

According to an embodiment, the sensor may be utilized by a perception module for obtaining the requested perception data among the perception modules. The method may include, after obtaining the requested perception data, identifying, by using the control module, that the perception module for obtaining the requested perception data has ceased utilizing the sensor. The method may include, based on identifying that the perception module for obtaining the requested perception data has ceased utilizing the sensor, identifying again, by using the control module, the operation state of each of the perception modules. The method may include, based on identifying, in accordance with the re-identified operation state of each of the perception modules, that the sensor is being utilized by at least one of the perception modules, maintaining, by using the control module, the state of the sensor as the activation state. The method may include, based on identifying, in accordance with the re-identified operation state of each of the perception modules, that the sensor is not being utilized by the perception modules, changing, by using the control module, the state of the sensor from the activation state to an inactivation state.

According to an embodiment, the method may include, based on identifying, in accordance with the re-identified operation state of each of the perception modules, that the sensor is being utilized by the at least one of the perception modules, identifying, by using the control module, a sensor setting corresponding to the at least one of the perception modules. The method may include, by applying the sensor setting to the sensor, maintaining, by using the control module, the state of the sensor as the activation state.

According to an embodiment, the method may include, based on identifying, in accordance with the identified operation state of each of the perception modules, that the sensor is not being utilized by the perception modules, changing, by using the control module, the state of the sensor from an inactivation state to the activation state. The method may include obtaining the requested perception data, by using sensor data obtained via the sensor changed as the activation state.

According to an embodiment, the sensor may be utilized by a perception module for obtaining the requested perception data among the perception modules. The method may include, after obtaining the requested perception data, identifying, by using the control module, that the perception module for obtaining the requested perception data has ceased utilizing the sensor. The method may include, based on identifying that the perception module for obtaining the requested perception data has ceased utilizing the sensor, identifying again, by using the control module, the operation state of each of the perception modules. The method may include, based on identifying, in accordance with the re-identified operation state of each of the perception modules, that the sensor is being utilized by at least one of the perception modules, maintaining, by using the control module, the state of the sensor as the activation state. The method may include, based on identifying, in accordance with the re-identified operation state of each of the perception modules, that the sensor is not being utilized by the perception modules, changing, by using the control module, the state of the sensor from the activation state to the inactivation state.

According to an embodiment, the method may include, based on identifying, in accordance with the re-identified operation state of each of the perception modules, that the sensor is being utilized by the at least one of the perception modules, identifying, by using the control module, a sensor setting corresponding to the at least one of the perception modules. The method may include, by applying the sensor setting to the sensor, maintaining, by using the control module, the state of the sensor as the activation state.

According to an embodiment, the perception modules may include at least one of circuitry or a sensor.

According to an embodiment, the control module may include circuitry.

According to an embodiment, the perception modules may include a hand tracking perception module.

According to an embodiment, the perception modules may include a head tracking perception module.

In a computer readable storage medium in which one or more computer programs are stored, as described above, the one or more computer programs may include computer-executable instructions to, when executed by one or more processors of a head-wearable electronic device individually or collectively, cause the head-wearable electronic device to identify an event requesting perception data generated by utilizing a system resource. The one or more computer programs may include computer-executable instructions to, when executed by the one or more processors individually or collectively, cause the head-wearable electronic device to, based on the event, identify an operation state of each of perception modules available in the head-wearable electronic device, by using a control module different from the perception modules. The one or more computer programs may include computer-executable instructions to, when executed by the one or more processors individually or collectively, cause the head-wearable electronic device to, based on identifying, in accordance with the identified operation state of each of the perception modules, that the system resource for generating the requested perception data is being utilized by one or more of the perception modules, obtain the requested perception data through the system resource utilized by the one or more of the perception modules. The one or more computer programs may include computer-executable instructions to, when executed by the one or more processors individually or collectively, cause the head-wearable electronic device to, based on identifying, in accordance with the identified operation state of each of the perception modules, that the system resource for generating the requested perception data is being unutilized by the perception modules, start, by using the control module, utilizing the system resource for obtaining the requested perception data.

According to an embodiment, the head-wearable electronic device may include a camera. The system resource for generating the requested perception data may include the camera. The one or more computer programs may include computer-executable instructions to, when executed by the one or more processors individually or collectively, cause the head-wearable electronic device to, based on identifying, in accordance with the identified operation state of each of the perception modules, that the camera for generating the requested perception data is being utilized by the one or more of the perception modules, maintain, by using the control module, a state of the camera as an activation state. The one or more computer programs may include computer-executable instructions to, when executed by the one or more processors individually or collectively, cause the head-wearable electronic device to obtain the requested perception data, using an image obtained via the camera being maintained in the activation state.

According to an embodiment, the camera may be utilized by a perception module for obtaining the requested perception data among the perception modules. The one or more computer programs may include computer-executable instructions to, when executed by the one or more processors individually or collectively, cause the head-wearable electronic device to, after obtaining the requested perception data, identify, by using the control module, that the perception module for obtaining the requested perception data has ceased utilizing the camera. The one or more computer programs may include computer-executable instructions to, when executed by the one or more processors individually or collectively, cause the head-wearable electronic device to, based on identifying that the perception module for obtaining the requested perception data has ceased utilizing the camera, identify again, by using the control module, the operation state of each of the perception modules. The one or more computer programs may include computer-executable instructions to, when executed by the one or more processors individually or collectively, cause the head-wearable electronic device to, based on identifying, in accordance with the re-identified operation state of each of the perception modules, that the camera is being utilized by at least one of the perception modules, maintain, by using the control module, the state of the camera as the activation state. The one or more computer programs may include computer-executable instructions to, when executed by the one or more processors individually or collectively, cause the head-wearable electronic device to, based on identifying, in accordance with the re-identified operation state of each of the perception modules, that the camera is not being utilized by the perception modules, change, by using the control module, the state of the camera from the activation state to an inactivation state.

According to an embodiment, the one or more computer programs may include computer-executable instructions to, when executed by the one or more processors individually or collectively, cause the head-wearable electronic device to, based on identifying, in accordance with the re-identified operation state of each of the perception modules, that the camera is being utilized by the at least one of the perception modules, identify, by using the control module, a camera setting corresponding to the at least one of the perception modules. The one or more computer programs may include computer-executable instructions to, when executed by the one or more processors individually or collectively, cause the head-wearable electronic device to, by applying the camera setting to the camera, maintain, by using the control module, the state of the camera as the activation state.

According to an embodiment, the one or more computer programs may include computer-executable instructions to, when executed by the one or more processors individually or collectively, cause the head-wearable electronic device to, based on identifying, in accordance with the identified operation state of each of the perception modules, that the camera is not being utilized by the perception modules, change, by using the control module, the state of the camera from an inactivation state to the activation state. The one or more computer programs may include computer-executable instructions to, when executed by the one or more processors individually or collectively, cause the head-wearable electronic device to obtain the requested perception data, by using an image obtained via the camera changed as the activation state.

According to an embodiment, the camera may be utilized by a perception module for obtaining the requested perception data among the perception modules. The one or more computer programs may include computer-executable instructions to, when executed by the one or more processors individually or collectively, cause the head-wearable electronic device to, after obtaining the requested perception data, identify, by using the control module, that the perception module for obtaining the requested perception data has ceased utilizing the camera. The one or more computer programs may include computer-executable instructions to, when executed by the one or more processors individually or collectively, cause the head-wearable electronic device to, based on identifying that the perception module for obtaining the requested perception data has ceased utilizing the camera, identify again, by using the control module, the operation state of each of the perception modules. The one or more computer programs may include computer-executable instructions to, when executed by the one or more processors individually or collectively, cause the head-wearable electronic device to, based on identifying, in accordance with the re-identified operation state of each of the perception modules, that the camera is being utilized by at least one of the perception modules, maintain, by using the control module, the state of the camera as the activation state. The one or more computer programs may include computer-executable instructions to, when executed by the one or more processors individually or collectively, cause the head-wearable electronic device to, based on identifying, in accordance with the re-identified operation state of each of the perception modules, that the camera is not being utilized by the perception modules, change, by using the control module, the state of the camera from the activation state to the inactivation state.

According to an embodiment, the one or more computer programs may include computer-executable instructions to, when executed by the one or more processors individually or collectively, cause the head-wearable electronic device to, based on identifying, in accordance with the re-identified operation state of each of the perception modules, that the camera is being utilized by the at least one of the perception modules, identify, by using the control module, a camera setting corresponding to the at least one of the perception modules. The one or more computer programs may include computer-executable instructions to, when executed by the one or more processors individually or collectively, cause the head-wearable electronic device to, by applying the camera setting to the camera, maintain, by using the control module, the state of the camera as the activation state.

According to an embodiment, the system resource for generating the requested perception data may include the at least one processor. The one or more computer programs may include computer-executable instructions to, when executed by the one or more processors individually or collectively, cause the head-wearable electronic device to, based on identifying, in accordance with the identified operation state of each of the perception modules, that the at least one processor for generating the requested perception data is being utilized by the one or more of the perception modules, identify, by using the control module, a scheduling priority level of a perception module for obtaining the requested perception data among the perception modules. The one or more computer programs may include computer-executable instructions to, when executed by the one or more processors individually or collectively, cause the head-wearable electronic device to, based on the scheduling priority level of the perception module for obtaining the requested perception data, perform, by using the control module, scheduling of the at least one processor. The one or more computer programs may include computer-executable instructions to, when executed by the one or more processors individually or collectively, cause the head-wearable electronic device to, based on the performed scheduling of the at least one processor, obtain the requested perception data.

According to an embodiment, the system resource for generating the requested perception data may include the memory. The one or more computer programs may include computer-executable instructions to, when executed by the one or more processors individually or collectively, cause the head-wearable electronic device to, based on identifying, in accordance with the identified operation state of each of the perception modules, that the memory for generating the requested perception data is being utilized by the one or more of the perception modules, identify, by using the control module, a perception module for obtaining the requested perception data among the perception modules. The one or more computer programs may include computer-executable instructions to, when executed by the one or more processors individually or collectively, cause the head-wearable electronic device to identify, by using the control module, that another perception module shared at least a portion of amount of the memory to be allocated to the perception module is included in the one or more of the perception modules utilizing the memory. The one or more computer programs may include computer-executable instructions to, when executed by the one or more processors individually or collectively, cause the head-wearable electronic device to, based on performing, by using the control module, memory resource allocation to the perception module in accordance with a difference between the amount of the memory to be allocated to the perception module and the at least a portion of the amount of the memory to be allocated to the perception module, obtain the requested perception data.

According to an embodiment, the one or more computer programs may include computer-executable instructions to, when executed by the one or more processors individually or collectively, cause the head-wearable electronic device to, based on the event, identify, by using the control module, an operation state of a perception module for obtaining the requested perception data among the perception modules. The one or more computer programs may include computer-executable instructions to, when executed by the one or more processors individually or collectively, cause the head-wearable electronic device to, based on identifying the operation state of the perception module being a resume state, maintain, by using the control module, the operation state of the perception module as the resume state. The one or more computer programs may include computer-executable instructions to, when executed by the one or more processors individually or collectively, cause the head-wearable electronic device to, based on identifying the operation state of the perception module being a suspend state, change, by using the control module, the operation state of the perception module from the suspend state to the resume state.

According to an embodiment, the one or more computer programs may include computer-executable instructions to, when executed by the one or more processors individually or collectively, cause the head-wearable electronic device to, in response to changing the operation state of the perception module from the suspend state to the resume state, change, by using the control module, an operation state of another perception module associated with the perception module among the perception modules from the suspend state to the resume state.

According to an embodiment, the one or more computer programs may include computer-executable instructions to, when executed by the one or more processors individually or collectively, cause the head-wearable electronic device to, after obtaining the requested perception data, identify whether a perception module for obtaining the requested perception data among the perception modules is used to obtain other perception data. The one or more computer programs may include computer-executable instructions to, when executed by the one or more processors individually or collectively, cause the head-wearable electronic device to, based on identifying that the perception module is used to obtain the other perception data, maintain, by using the control module, the operation state of the perception module as a resume state. The one or more computer programs may include computer-executable instructions to, when executed by the one or more processors individually or collectively, cause the head-wearable electronic device to, based on identifying that the perception module is not used to obtain the other perception data, change, by using the control module, the operation state of the perception module from the resume state to a suspend state.

According to an embodiment, the head-wearable electronic device may include a sensor. The system resource for generating the requested perception data may include the sensor. The one or more computer programs may include computer-executable instructions to, when executed by the one or more processors individually or collectively, cause the head-wearable electronic device to, based on identifying, in accordance with the identified operation state of each of the perception modules, that the sensor for generating the requested perception data is being utilized by the one or more of the perception modules, maintain, by using the control module, a state of the sensor as an activation state. The one or more computer programs may include computer-executable instructions to, when executed by the one or more processors individually or collectively, cause the head-wearable electronic device to obtain the requested perception data, using sensor data obtained via the sensor being maintained in the activation state.

According to an embodiment, the sensor may be utilized by a perception module for obtaining the requested perception data among the perception modules. The one or more computer programs may include computer-executable instructions to, when executed by the one or more processors individually or collectively, cause the head-wearable electronic device to, after obtaining the requested perception data, identify, by using the control module, that the perception module for obtaining the requested perception data has ceased utilizing the camera. The one or more computer programs may include computer-executable instructions to, when executed by the one or more processors individually or collectively, cause the head-wearable electronic device to, based on identifying that the perception module for obtaining the requested perception data has ceased utilizing the sensor, identify again, by using the control module, the operation state of each of the perception modules. The one or more computer programs may include computer-executable instructions to, when executed by the one or more processors individually or collectively, cause the head-wearable electronic device to, based on identifying, in accordance with the re-identified operation state of each of the perception modules, that the sensor is being utilized by at least one of the perception modules, maintain, by using the control module, the state of the sensor as the activation state. The one or more computer programs may include computer-executable instructions to, when executed by the one or more processors individually or collectively, cause the head-wearable electronic device to, based on identifying, in accordance with the re-identified operation state of each of the perception modules, that the sensor is not being utilized by the perception modules, change, by using the control module, the state of the sensor from the activation state to an inactivation state.

According to an embodiment, the one or more computer programs may include computer-executable instructions to, when executed by the one or more processors individually or collectively, cause the head-wearable electronic device to, based on identifying, in accordance with the re-identified operation state of each of the perception modules, that the sensor is being utilized by the at least one of the perception modules, identify, by using the control module, a sensor setting corresponding to the at least one of the perception modules. The one or more computer programs may include computer-executable instructions to, when executed by the one or more processors individually or collectively, cause the head-wearable electronic device to, by applying the sensor setting to the sensor, maintain, by using the control module, the state of the sensor as the activation state.

According to an embodiment, the one or more computer programs may include computer-executable instructions to, when executed by the one or more processors individually or collectively, cause the head-wearable electronic device to, based on identifying, in accordance with the identified operation state of each of the perception modules, that the sensor is not being utilized by the perception modules, change, by using the control module, the state of the sensor from an inactivation state to the activation state. The one or more computer programs may include computer-executable instructions to, when executed by the one or more processors individually or collectively, cause the head-wearable electronic device to obtain the requested perception data, by using sensor data obtained via the sensor changed as the activation state.

According to an embodiment, the sensor may be utilized by a perception module for obtaining the requested perception data among the perception modules. The one or more computer programs may include computer-executable instructions to, when executed by the one or more processors individually or collectively, cause the head-wearable electronic device to, after obtaining the requested perception data, identify, by using the control module, that the perception module for obtaining the requested perception data has ceased utilizing the sensor. The one or more computer programs may include computer-executable instructions to, when executed by the one or more processors individually or collectively, cause the head-wearable electronic device to, based on identifying that the perception module for obtaining the requested perception data has ceased utilizing the sensor, identify again, by using the control module, the operation state of each of the perception modules. The one or more computer programs may include computer-executable instructions to, when executed by the one or more processors individually or collectively, cause the head-wearable electronic device to, based on identifying, in accordance with the re-identified operation state of each of the perception modules, that the sensor is being utilized by at least one of the perception modules, maintain, by using the control module, the state of the sensor as the activation state. The one or more computer programs may include computer-executable instructions to, when executed by the one or more processors individually or collectively, cause the head-wearable electronic device to, based on identifying, in accordance with the re-identified operation state of each of the perception modules, that the sensor is not being utilized by the perception modules, change, by using the control module, the state of the sensor from the activation state to the inactivation state.

According to an embodiment, the one or more computer programs may include computer-executable instructions to, when executed by the one or more processors individually or collectively, cause the head-wearable electronic device to, based on identifying, in accordance with the re-identified operation state of each of the perception modules, that the sensor is being utilized by the at least one of the perception modules, identify, by using the control module, a sensor setting corresponding to the at least one of the perception modules. The one or more computer programs may include computer-executable instructions to, when executed by the one or more processors individually or collectively, cause the head-wearable electronic device to, by applying the sensor setting to the sensor, maintain, by using the control module, the state of the sensor as the activation state.

According to an embodiment, the perception modules may include at least one of circuitry or a sensor.

According to an embodiment, the control module may include circuitry.

According to an embodiment, the perception modules may include a hand tracking perception module.

According to an embodiment, the perception modules may include a head tracking perception module.

For one or more embodiments, at least one of the components described in one or more of the preceding drawings may be configured to perform one or more operations, techniques, processes, and/or methods as described in the disclosure. For example, the processor (e.g., a baseband processor) described in the disclosure in association with the one or more of the preceding drawings may be configured to operate according to one or more examples described in the disclosure. For another example, circuitry associated with a user equipment (UE), a base station, a network element, and the like, as described above in association with one or more of the previous drawings, may be configured to operate according to the one or more examples described herein.

Any of the embodiments described above may be combined with any other embodiment (or a combination of embodiments) unless explicitly stated otherwise. The foregoing description of one or more implementations provides examples and descriptions, but is not intended to be exhaustive or limit the scope of the embodiments to the precise forms disclosed. In light of the above teachings, modifications and variations may be made or may be obtained from the practice of various embodiments.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

No claim element is to be construed under the provisions of 35 U.S.C. §112, sixth paragraph, unless the element is expressly recited using the phrase “means for” or “means”.

What is claimed is:

1. A head-wearable electronic device comprising:
at least one processor comprising processing circuitry; and
memory communicatively coupled to the at least one processor, the memory comprising one or more storage media storing instructions that, when executed by the at least one processor individually or collectively, cause the head-wearable electronic device to:
identify an event requesting perception data generated by utilizing a system resource,
based on the event, identify an operation state of each of perception modules available in the head-wearable electronic device, by using a control module different from the perception modules,
based on identifying, in accordance with the identified operation state of each of the perception modules, that the system resource for generating the requested perception data is being utilized by one or more of the perception modules, obtain the requested perception data through the system resource utilized by the one or more of the perception modules, and
based on identifying, in accordance with the identified operation state of each of the perception modules, that the system resource for generating the requested perception data is being unutilized by the perception modules, start, by using the control module, utilizing the system resource for obtaining the requested perception data.

2. The head-wearable electronic device of claim 1, further comprising:
a camera,
wherein the system resource for generating the requested perception data includes the camera, and
wherein the instructions, when executed by the at least one processor individually or collectively, cause the head-wearable electronic device to:
based on identifying, in accordance with the identified operation state of each of the perception modules, that the camera for generating the requested perception data is being utilized by the one or more of the perception modules, maintain, by using the control module, a state of the camera as an activation state, and
obtain the requested perception data, using an image obtained via the camera being maintained in the activation state.

3. The head-wearable electronic device of claim 2,
wherein the camera is utilized by a perception module for obtaining the requested perception data among the perception modules, and
wherein the instructions, when executed by the at least one processor individually or collectively, further cause the head-wearable electronic device to:
after obtaining the requested perception data, identify, by using the control module, that the perception module for obtaining the requested perception data has ceased utilizing the camera,
based on identifying that the perception module for obtaining the requested perception data has ceased utilizing the camera, identify again, by using the control module, the operation state of each of the perception modules,
based on identifying, in accordance with the re-identified operation state of each of the perception modules, that the camera is being utilized by at least one of the perception modules, maintain, by using the control module, the state of the camera as the activation state, and
based on identifying, in accordance with the re-identified operation state of each of the perception modules, that the camera is being unutilized by the perception modules, change, by using the control module, the state of the camera from the activation state to an inactivation state.

4. The head-wearable electronic device of claim 3, wherein the instructions, when executed by the at least one processor individually or collectively, further cause the head-wearable electronic device to:
based on identifying, in accordance with the re-identified operation state of each of the perception modules, that the camera is being utilized by the at least one of the perception modules, identify, by using the control module, a camera setting corresponding to the at least one of the perception modules; and
by applying the camera setting to the camera, maintain, by using the control module, the state of the camera as the activation state.

5. The head-wearable electronic device of claim 2, wherein the instructions, when executed by the at least one processor individually or collectively, cause the head-wearable electronic device to:
based on identifying, in accordance with the identified operation state of each of the perception modules, that the camera is being unutilized by the perception modules, change, by using the control module, the state of the camera from an inactivation state to the activation state; and
obtain the requested perception data, by using an image obtained via the camera changed as the activation state.

6. The head-wearable electronic device of claim 5,
wherein the camera is utilized by a perception module for obtaining the requested perception data among the perception modules, and
wherein the instructions, when executed by the at least one processor individually or collectively, further cause the head-wearable electronic device to:
after obtaining the requested perception data, identify, by using the control module, that the perception module for obtaining the requested perception data has ceased utilizing the camera,
based on identifying that the perception module for obtaining the requested perception data has ceased utilizing the camera, identify again, by using the control module, the operation state of each of the perception modules,
based on identifying, in accordance with the re-identified operation state of each of the perception modules, that the camera is being utilized by at least one of the perception modules, maintain, by using the control module, the state of the camera as the activation state, and
based on identifying, in accordance with the re-identified operation state of each of the perception modules, that the camera is being unutilized by the perception modules, change, by using the control module, the state of the camera from the activation state to the inactivation state.

7. The head-wearable electronic device of claim 6, wherein the instructions, when executed by the at least one processor individually or collectively, further cause the head-wearable electronic device to:
based on identifying, in accordance with the re-identified operation state of each of the perception modules, that the camera is being utilized by the at least one of the perception modules, identify, by using the control module, a camera setting corresponding to the at least one of the perception modules; and
by applying the camera setting to the camera, maintain, by using the control module, the state of the camera as the activation state.

8. The head-wearable electronic device of claim 1,
wherein the system resource for generating the requested perception data includes the at least one processor, and
wherein the instructions, when executed by the at least one processor individually or collectively, cause the head-wearable electronic device to:
based on identifying, in accordance with the identified operation state of each of the perception modules, that the at least one processor for generating the requested perception data is being utilized by the one or more of the perception modules, identify, by using the control module, a scheduling priority level of a perception module for obtaining the requested perception data among the perception modules,
based on the scheduling priority level of the perception module for obtaining the requested perception data, perform, by using the control module, scheduling of the at least one processor, and
based on the performed scheduling of the at least one processor, obtain the requested perception data.

9. The head-wearable electronic device of claim 1,
wherein the system resource for generating the requested perception data includes the memory, and
wherein the instructions, when executed by the at least one processor individually or collectively, cause the head-wearable electronic device to:
based on identifying, in accordance with the identified operation state of each of the perception modules, that the memory for generating the requested perception data is being utilized by the one or more of the perception modules, identify, by using the control module, a perception module for obtaining the requested perception data among the perception modules,
identify, by using the control module, that another perception module shared at least a portion of amount of the memory to be allocated to the perception module is included in the one or more of the perception modules utilizing the memory, and
based on performing, by using the control module, memory resource allocation to the perception module in accordance with a difference between the amount of the memory to be allocated to the perception module and the at least a portion of the amount of the memory to be allocated to the perception module, obtain the requested perception data.

10. The head-wearable electronic device of claim 1, wherein the instructions, when executed by the at least one processor individually or collectively, further cause the head-wearable electronic device to:
based on the event, identify, by using the control module, an operation state of a perception module for obtaining the requested perception data among the perception modules;
based on identifying the operation state of the perception module being a resume state, maintain, by using the control module, the operation state of the perception module as the resume state; and
based on identifying the operation state of the perception module being a suspend state, change, by using the control module, the operation state of the perception module from the suspend state to the resume state.

11. The head-wearable electronic device of claim 10, wherein the instructions, when executed by the at least one processor individually or collectively, further cause the head-wearable electronic device to:
in response to changing the operation state of the perception module from the suspend state to the resume state, change, by using the control module, an operation state of another perception module associated with the perception module among the perception modules from the suspend state to the resume state.

12. The head-wearable electronic device of claim 1, wherein the instructions, when executed by the at least one processor individually or collectively, further cause the head-wearable electronic device to:
after obtaining the requested perception data, identify whether a perception module for obtaining the requested perception data among the perception modules is used to obtain other perception data;
based on identifying that the perception module is used to obtain the other perception data, maintain, by using the control module, the operation state of the perception module as a resume state; and
based on identifying that the perception module is unused to obtain the other perception data, change, by using the control module, the operation state of the perception module from the resume state to a suspend state.

13. The head-wearable electronic device of claim 1, further comprising:
a sensor,
wherein the system resource for generating the requested perception data includes the sensor, and
wherein the instructions, when executed by the at least one processor individually or collectively, cause the head-wearable electronic device to:
based on identifying, in accordance with the identified operation state of each of the perception modules, that the sensor for generating the requested perception data is being utilized by the one or more of the perception modules, maintain, by using the control module, a state of the sensor as an activation state, and
obtain the requested perception data, using sensor data obtained via the sensor being maintained in the activation state.

14. The head-wearable electronic device of claim 13,
wherein the sensor is utilized by a perception module for obtaining the requested perception data among the perception modules, and
wherein the instructions, when executed by the at least one processor individually or collectively, further cause the head-wearable electronic device to:
after obtaining the requested perception data, identify, by using the control module, that the perception module for obtaining the requested perception data has ceased utilizing the sensor,
based on identifying that the perception module for obtaining the requested perception data has ceased utilizing the sensor, identify again, by using the control module, the operation state of each of the perception modules,
based on identifying, in accordance with the re-identified operation state of each of the perception modules, that the sensor is being utilized by at least one of the perception modules, maintain, by using the control module, the state of the sensor as the activation state, and
based on identifying, in accordance with the re-identified operation state of each of the perception modules, that the sensor is being unutilized by the perception modules, change, by using the control module, the state of the sensor from the activation state to an inactivation state.

15. The head-wearable electronic device of claim 14, wherein the instructions, when executed by the at least one processor individually or collectively, further cause the head-wearable electronic device to:
based on identifying, in accordance with the re-identified operation state of each of the perception modules, that the sensor is being utilized by the at least one of the perception modules, identify, by using the control module, a sensor setting corresponding to the at least one of the perception modules; and
by applying the sensor setting to the sensor, maintain, by using the control module, the state of the sensor as the activation state.

16. The head-wearable electronic device of claim 13, wherein the instructions, when executed by the at least one processor individually or collectively, further cause the head-wearable electronic device to:
based on identifying, in accordance with the identified operation state of each of the perception modules, that the sensor is being unutilized by the perception modules, change, by using the control module, the state of the sensor from an inactivation state to the activation state; and
obtain the requested perception data, by using sensor data obtained via the sensor changed as the activation state.

17. The head-wearable electronic device of claim 16,
wherein the sensor is utilized by a perception module for obtaining the requested perception data among the perception modules, and
wherein the instructions, when executed by the at least one processor individually or collectively, further cause the head-wearable electronic device to:
after obtaining the requested perception data, identify, by using the control module, that the perception module for obtaining the requested perception data has ceased utilizing the sensor,
based on identifying that the perception module for obtaining the requested perception data has ceased utilizing the sensor, identify again, by using the control module, the operation state of each of the perception modules,
based on identifying, in accordance with the re-identified operation state of each of the perception modules, that the sensor is being utilized by at least one of the perception modules, maintain, by using the control module, the state of the sensor as the activation state, and
based on identifying, in accordance with the re-identified operation state of each of the perception modules, that the sensor is unutilized by the perception modules, change, by using the control module, the state of the sensor from the activation state to the inactivation state.

18. The head-wearable electronic device of claim 17, wherein the instructions, when executed by the at least one processor individually or collectively, further cause the head-wearable electronic device to:
based on identifying, in accordance with the re-identified operation state of each of the perception modules, that the sensor is being utilized by the at least one of the perception modules, identify, by using the control module, a sensor setting corresponding to the at least one of the perception modules; and
by applying the sensor setting to the sensor, maintain, by using the control module, the state of the sensor as the activation state.

19. A method performed by a head-wearable electronic device, the method comprising:
identifying, by at least one processor of the head-wearable device, an event requesting perception data generated by utilizing a system resource;
based on the event, identifying, by the at least one processor, an operation state of each of perception modules available in the head-wearable electronic device, by using a control module different from the perception modules;
based on identifying, in accordance with the identified operation state of each of the perception modules, that the system resource for generating the requested perception data is being utilized by one or more of the perception modules, obtaining the requested perception data through the system resource utilized by the one or more of the perception modules; and
based on identifying, in accordance with the identified operation state of each of the perception modules, that the system resource for generating the requested perception data is being unutilized by the perception modules, starting, by using the control module, utilizing the system resource for obtaining the requested perception data.

20. A non-transitory computer readable storage medium storing one or more computer programs, the one or more computer programs comprising computer-executable instructions that, when executed by one or more processors of a head-wearable electronic device individually or collectively, cause the head-wearable electronic device to perform operations, the operations comprising:
identifying an event requesting perception data generated by utilizing a system resource;
based on the event, identifying an operation state of each of perception modules available in the head-wearable electronic device, by using a control module different from the perception modules;
based on identifying, in accordance with the identified operation state of each of the perception modules, that the system resource for generating the requested perception data is being utilized by one or more of the perception modules, obtaining the requested perception data through the system resource utilized by the one or more of the perception modules; and
based on the identifying, in accordance with the identified operation state of each of the perception modules, that the system resource for generating the requested perception data is being unutilized by the perception modules, starting, by using the control module, utilization of the system resource for obtaining the requested perception data.
